(19) United States
(12) Patent Application Publication
(10) Pub. No.: US 2009/0152876 A1
(43) Pub. Date: Jun. 18, 2009

(54) Latching device

(76) Inventor: Hong-Yao Chen, Taipei City (TW)

Correspondence Address: Troxell Law Office Pllc, Suite 1404, 5205 Leesburg Pike, Falls Church, VA, 22041, US

(21) Appl. No.: 12/000,551

(22) Filed: Dec. 13, 2007

(51) Int. Cl. E05C 1/08

(52) U.S. Cl. 292/164; 292/251.5; 292/341.16

(57) ABSTRACT

A latching device, which includes a lock frame mechanism fitted to a door and a corresponding latching mechanism fitted to a door frame. The lock frame mechanism is fixed to the inner side of the door, and is provided with a long locking arm able to horizontally swing, and the latching mechanism is provided with an extensible latch. When the latching device forms an unlatched state, the latch retracts to the side of the latching mechanism side, thereby achieving the effectiveness of preventing people from getting caught on a latch button when passing in and out and further giving an integrated aesthetic appearance to the door assembly.

### BACKGROUND OF THE INVENTION

(a) Field of the Invention

The present invention relates to a latching device, and more particularly to a safety device for a door assembly which is installed between the indoor side of a door and the door frame. When the device forms an unlatched state, then a latch in an extension mechanism retracts to a side of a latching mechanism, thereby achieving the effectiveness of preventing people from getting caught on the latch button when passing in and out, as well as further giving an integrated aesthetic appearance to the door assembly.

(b) Description of the Prior Art

In general, people will install a latching device for protection between the door and the door frame in order to acquire good residential quality and guarantee safety. The latching device only allows the door to open to an appropriate clearance when in a latched state, and prevents the door from being completely opened, and only after confirming the visitor through the aforementioned clearance is a decision made whether or not to open the door, thereby ensuring safety of the individual and property.

However, a latching device of the prior art (as depicted in FIG. 34) primarily comprises a base 1, on which is pivotal configured a locking arm 2, fixed to an inner surface (indoor side) of a door 3 close to one side of a handle 4, thereby enabling a free end of the locking arm 2 to inwardly swing. In addition, a latch 6 is fixed to a door frame 5 corresponding to the aforementioned locking arm 2. Accordingly, when the latch 6 inserts into a slide groove 7, then the latch 6 is only able to move within the range of the slide groove 7, thereby enabling the door 3 to only open to an appropriate clearance (that is, a half-open state). Conversely, when the locking arm 2 is flush with the door 3 and separated from the latch 6, then an unlatched state is formed and enables the door to be completely opened.

However, the latch 6 of the aforementioned latching device of the prior art is fixed to the door frame 5 and protrudes inwardly (direction of the door). Hence, when people pass in and out the entrance (hall), their body or baggage is very easily caught on the latch 6 causing bodily injury or damage to the baggage. Furthermore, the latch 6 protruding out from the door frame 5 also adversely affects the aesthetic appearance of the main entrance. Accordingly, there is a real need for further research and improvement in the aforementioned latching device of the prior art.

### SUMMARY OF THE INVENTION

In light of the shortcomings easily brought about by the aforementioned latching device of the prior art when in actual use, the inventor of the present invention, having accumulated years of experience in related engineering design and structure, has meticulously carried out extensive study and exploration to ultimately design a new improved structure latching device.

A primary objective of the present invention is to provide a latching device, in which a latch is able to extend and insert into a slide groove of a locking arm subject to the control of a drive element, or retract to the side of a latching mechanism, and thereby achieve the protective effectiveness of latching and unlocking.

Another objective of the present invention is to provide the latching device, in which when the latch forms an unlatched state and retracts to one side of the latching mechanism, then it achieves the effectiveness of preventing people from getting caught on the latch when passing in and out, as well as further giving an integrated aesthetic appearance to the door assembly.

In order to achieve the aforementioned objectives, the latching device of the present invention is structured to comprise a lock frame mechanism fitted to a door and a corresponding latching mechanism fitted to a door frame. The present invention is characterized in that: the lock frame mechanism comprises a base and a locking arm, in which the base is fixed to the inner side of the door, and the locking arm is pivotal configured on the base and able to horizontally swing. Moreover, a slide groove is defined within the locking arm, and a drive element is located on the base or close to a pin connected position of the locking arm. The latching mechanism comprises a base and an extension mechanism provided with a latch, in which the base is fixed to the door frame and is used to enable the extension mechanism to be fitted thereto, and the extension mechanism functions in correspondence with the drive element. Accordingly, the extension mechanism is subject to the control of the drive element, and causes the latch to extend towards the lock frame mechanism and form a latched state. Similarly, control by or release from the control of the drive element is used to cause the latch extending towards the lock frame mechanism to retract to the side of the latching mechanism and form an unlatched state.

According to aforementioned assemblage and operation of the device, when the door is closed, the latch is subjected to the control of the drive element corresponding to the extension mechanism and extends toward the direction of the lock frame mechanism to form a latched state. Hence, then the latch is able to insert into the slide groove of the locking arm to enable the door to be only opened a suitable clearance, thereby achieving the effectiveness of a safety protection latching device. Moreover, when a user rotates the locking arm flush with the door and opens the door, then the latch, because of the drive element subjecting control or releasing control of the extension mechanism, retracts to the side of the latching mechanism to form an unlatched state, thereby achieving the effectiveness of preventing people from getting caught on an extended latch button when passing in and out, as well as further giving an integrated aesthetic appearance to the door assembly.

To enable a further understanding of said objectives and the technological methods of the invention herein, a brief description of the drawings is provided below followed by a detailed description of the preferred embodiments.

### BRIEF DESCRIPTION OF THE DRAWINGS

FIGS. 1˜4 show views of a first embodiment of a latching device of the present invention.

FIG. 1 (a) shows a front view of an unlatched state, (b) shows a front view of a latched state.

FIG. 2 shows an assembled view of the latching device, (a) shows two views of the latching device, (b) shows the latch in a retracted state, (c) shows the latch in an extended state.

FIG. 3 shows an assembled view of a lock frame mechanism, (a) and (b) show a front view and a bottom view respectively of the lock frame mechanism, (c) shows a state diagram depicting the locking arm pulled open.

FIG. 4 shows a parts drawing of the latching mechanism, (a) shows two views of a base, (b) shows three views of the latch, (c) shows three views of a toothed bar, (d) shows two views of an idle gear.

FIGS. 5˜6 show views of a second embodiment of the latching device of the present invention.

FIG. 5 (a) shows a front view of an unlatched state, (b) shows a front view of a latched state.

FIG. 6 shows an assembled view of the latching mechanism, (a) shows two views of the latching mechanism, (b) shows the latch in a retracted state, (c) shows the latch in an extended state.

FIG. 7 shows an assembled view of the lock frame mechanism, (a) and (b) show a front view and a bottom view respectively of the lock frame mechanism, (c) shows a state diagram depicting the locking arm pulled open.

FIG. 8 shows a parts drawing of the latching mechanism, (a) shows two views of the base, (b) shows three views of the latch, (c) shows three views of the toothed bar, (d) shows two views of the idle gear.

FIGS. 9˜12 show views of a third embodiment of the latching device of the present invention.

FIG. 9 (a) shows a front view of an unlatched state, (b) shows a front view of the latch in an extended state when a door is closed to a fixed position, (c) shows a front view of a latched state.

FIG. 10 shows an assembled view of the latching mechanism, (a) shows two views of the latching mechanism, (b) shows the latch in retracted state, (c) shows the latch in an extended state.

FIG. 11 shows an assembled view of the lock frame mechanism, (a), (b) and (d) show respectively show a view of the lock frame mechanism, (c) shows a state diagram of the locking arm pulled open.

FIG. 12 shows a parts drawing of the latching mechanism, (a) shows three views of the base, (b) shows three views of the latch, (c) shows two views of a positioning pin, (d) shows a plan view depicting another embodiment of the latch horizontal plan.

FIGS. 13˜15 show a fourth embodiment of the latching device of the present invention.

FIG. 13 (a) shows a front view of an unlatched state, (b) shows a front view of the latch in an extended state when a door is closed to a fixed position, (c) shows a front view of a latched state.

FIG. 14 shows an assembled view of the latching mechanism, (a) shows three views of the latching mechanism in an unlatched state, (b) shows three views of the latching mechanism in a latched state.

FIG. 15 shows a parts drawing of the latching mechanism, (a) shows three views of the base, (b) shows two views of the latch.

FIGS. 16˜17 show a fifth embodiment of the latching device of the present invention.

FIG. 16 (a) shows a view of the latch in an extended state when a door is closed to a fixed position, (b) shows a front view of a latched state, (c) shows a front view of an unlatched state.

FIG. 17 shows an assembled view of an L arm in the latching mechanism, (a) shows a view of the L arm in a compressed state with a toothed portion, (b) shows the L arm in an elongated state with the toothed portion.

FIG. 18 shows a sixth embodiment of the latching device of the present invention, (a) shows a view of the latch in an extended state when a door is closed to a fixed position, (b) shows a front view of a latched state, (c) shows a front view of an unlatched state.

FIG. 19 shows a seventh embodiment of the latching device of the present invention, (a) shows a view of the latch in an extended state when a door is closed to a fixed position, (b) shows a front view of a latched state, (c) shows a front view of an unlatched state.

FIG. 20 shows a eighth embodiment of the latching device of the present invention, (a) shows a view of the latch in an extended state when a door is closed to a fixed position, (b) shows a front view of a latched state, (c) shows a front view of an unlatched state.

FIGS. 21˜23 show a ninth embodiment of the latching device of the present invention.

FIGS. 21 (a) and (b) respectively show a view of the latch in an extended state when a door is closed.

FIG. 22 shows an assembled view of the latching mechanism, (a) and (b) respectively show a view of the latching mechanism in an unlatched state, (c) and (d) respectively show a view of the latching mechanism in a latched state.

FIG. 23 shows a parts drawing of the latching mechanism, (a) shows two views of the latch, (b) shows a side view of a drive gear, (c) shows three views of the base.

FIGS. 24˜26 show a tenth embodiment of the latching device of the present invention.

FIG. 24 (a) shows a front view of the latch in an extended state when a door is closed to a fixed position, (b) shows a bottom view of the latch in an extended state when a door is closed to a fixed position.

FIG. 25 shows an assembled view of the latching mechanism, (a) and (b) respectively show a view of the latching mechanism in an unlatched state, (c) and (d) respectively show a view of the latching mechanism in a latched state.

FIG. 26 shows a parts drawing of the latching mechanism, (a) shows two views of the latch, (b) shows two views of a rotating wheel, (c) shows a front view of a rotating shaft, (d) shows three views of the base, (e) shows two views of another embodiment of the rotating wheel.

FIGS. 27˜28 show an eleventh embodiment of the latching device of the present invention.

FIGS. 27 (a) and (b) respectively show a view of the latch in an extended state when a door is closed to a fixed position, (c) and (d) respectively show a view of the latching mechanism in a latched state, (e) and (f) respectively show a view of the latching mechanism in an unlatched state.

FIG. 28 shows a parts drawing of the latching mechanism, (a) shows four views of the latch, (b) shows three views of the base, (c) shows three views of the rotating wheel, (d) shows a front view of another embodiment of the rotating wheel.

FIG. 29 shows a twelfth embodiment of the latching device of the present invention, (a) shows a front view of the latch in an extended state when a door is closed to a fixed position, (b) shows a front view of the latching mechanism in an unlatched state.

FIGS. 30˜32 show a thirteenth embodiment of the latching device of the present invention.

FIG. 30 (a) shows a front view of the latch in an extended state when a door is closed to a fixed position, (b) shows a bottom view of the latch in an extended state when a door is closed to a fixed position.

FIG. 31 shows a parts drawing of the latching mechanism, (a) and (b) respectively show a view of the latching mechanism in an unlatched state, (c) and (d) respectively show a view of the latching mechanism in a latched state.

FIG. 32 shows a parts drawing of the latching mechanism, (a) shows two views of the latch, (b) shows three views of the base.

FIG. 33 shows a fourteenth embodiment of the latching device of the present invention, (a) shows a front view of the latch in an extended state when a door is closed to a fixed position, (b) shows a bottom view of the latch in an extended state when a door is closed to a fixed position.

FIG. 34 shows a latching device of the prior art, (a) shows a front view of a locking arm fitted to a door, (b) shows a plan view of the device in a latched state, (c) shows a planar schematic view of an opened door when the device is in a latched state, (d) shows a plan view of the device in an unlatched state.

### DETAILED DESCRIPTION OF THE PREFERRED EMBODIMENTS

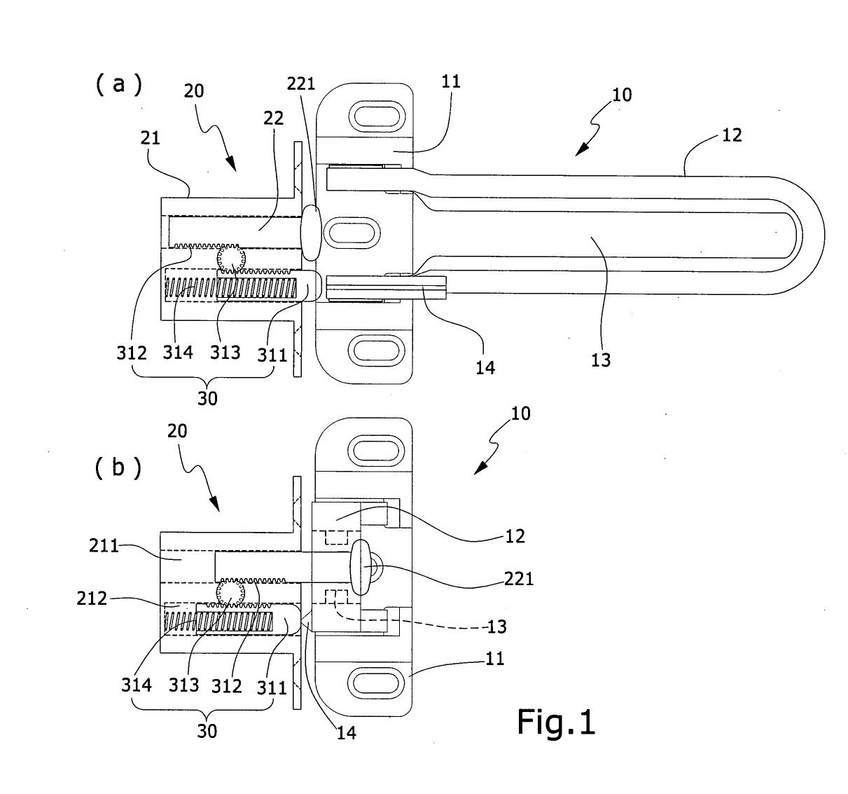

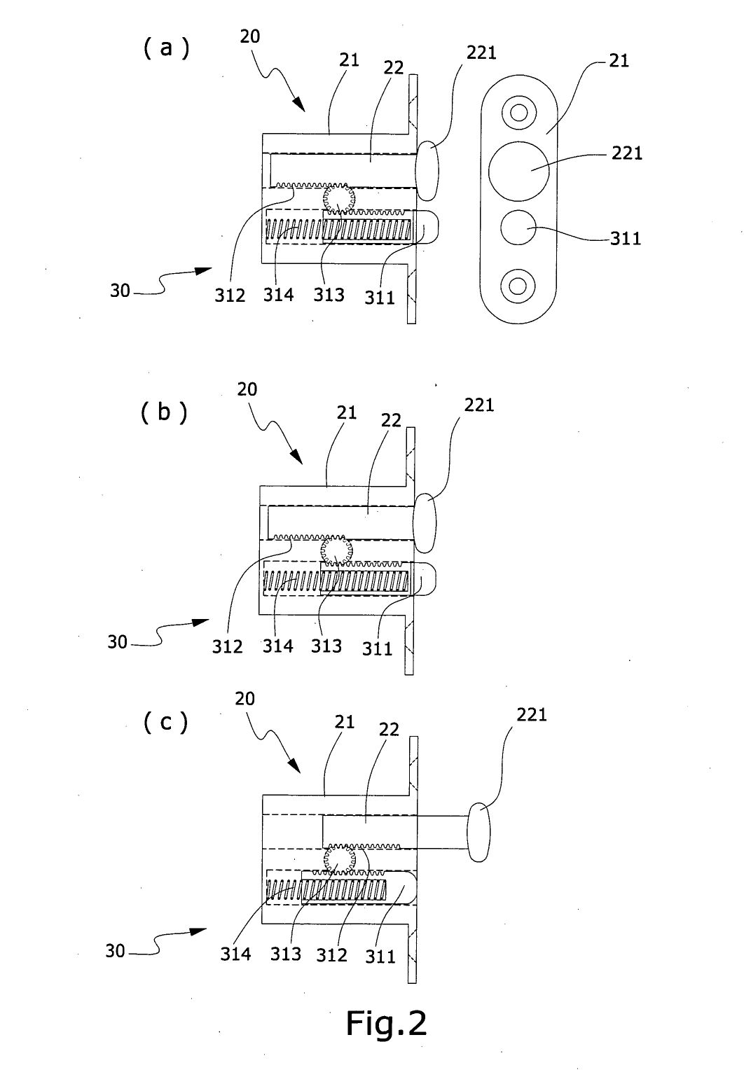

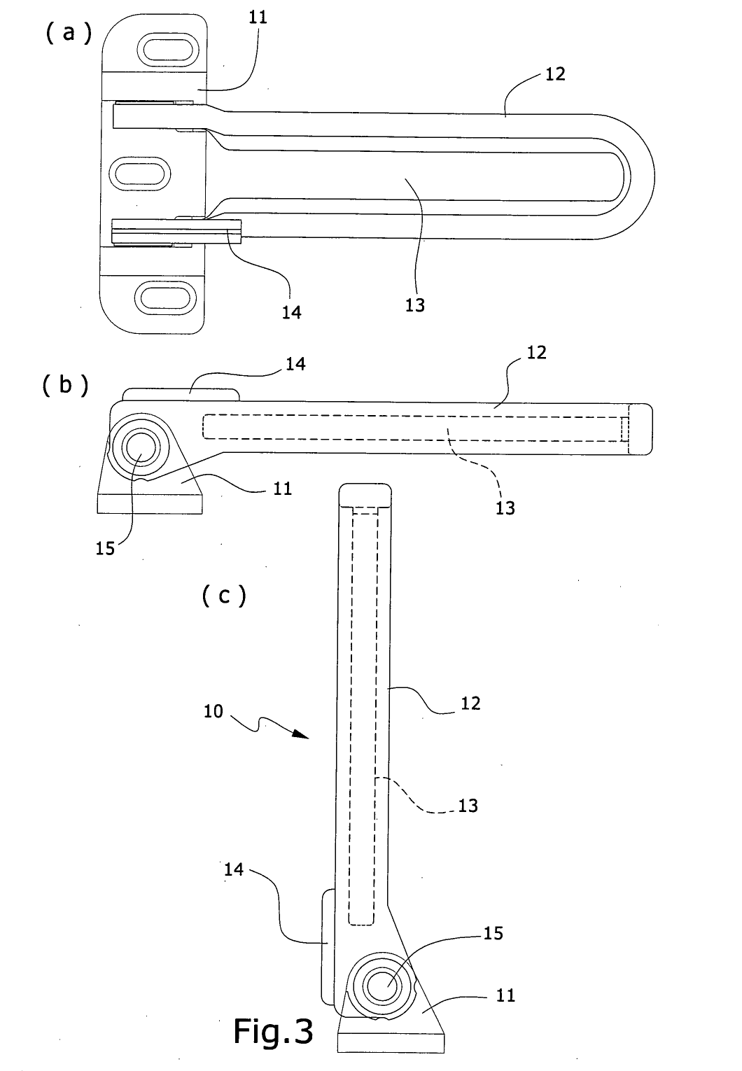

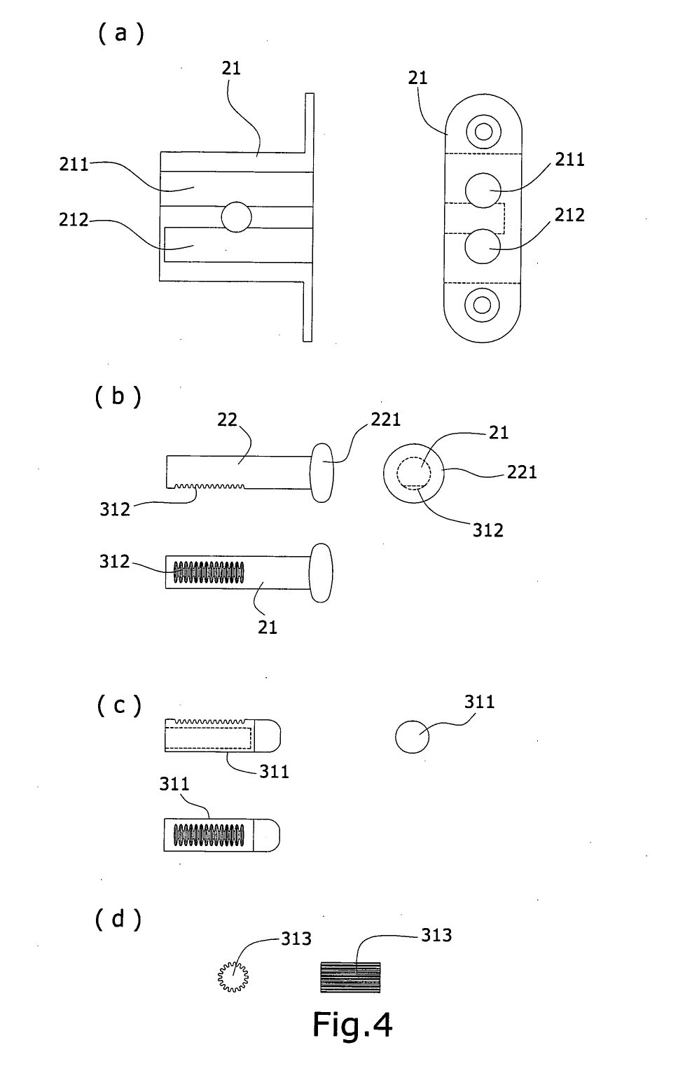

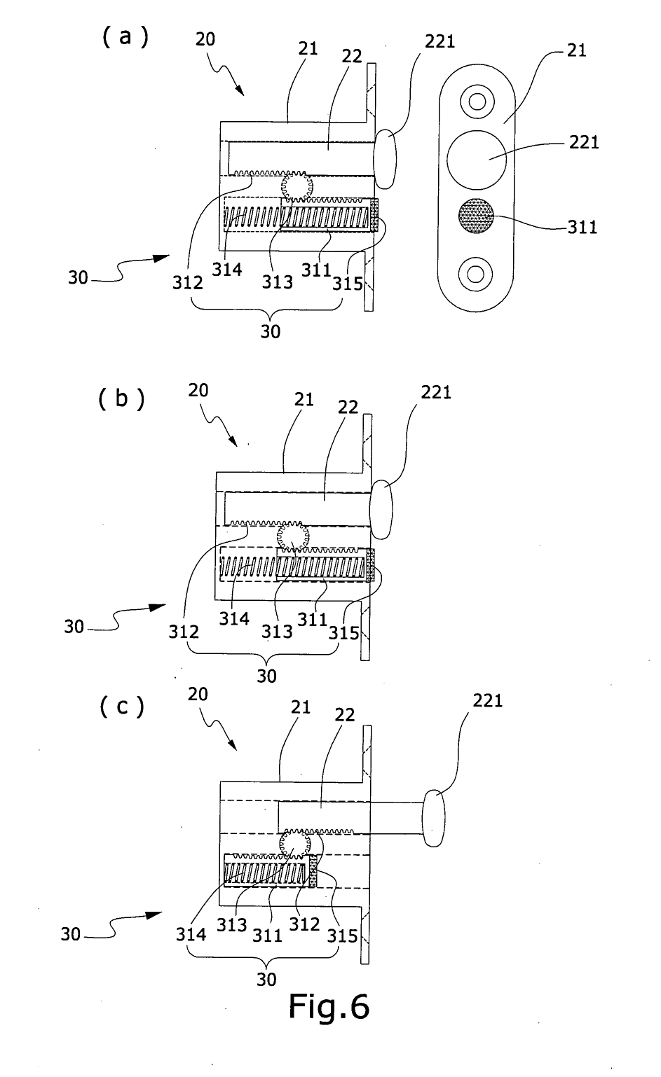

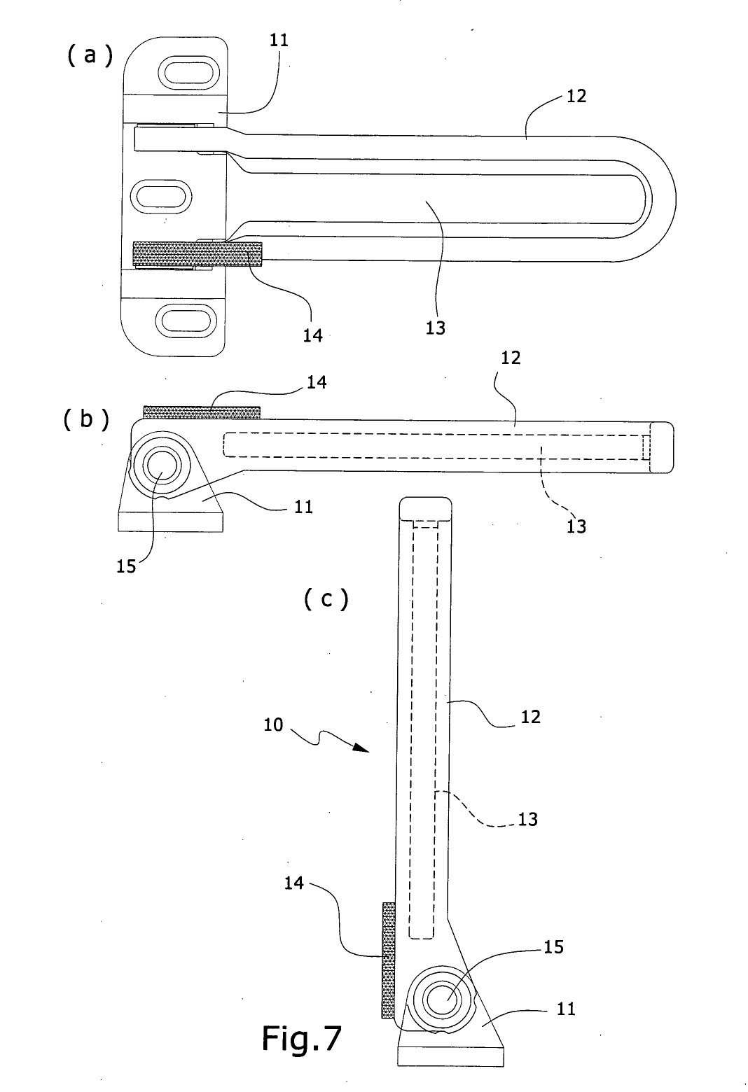

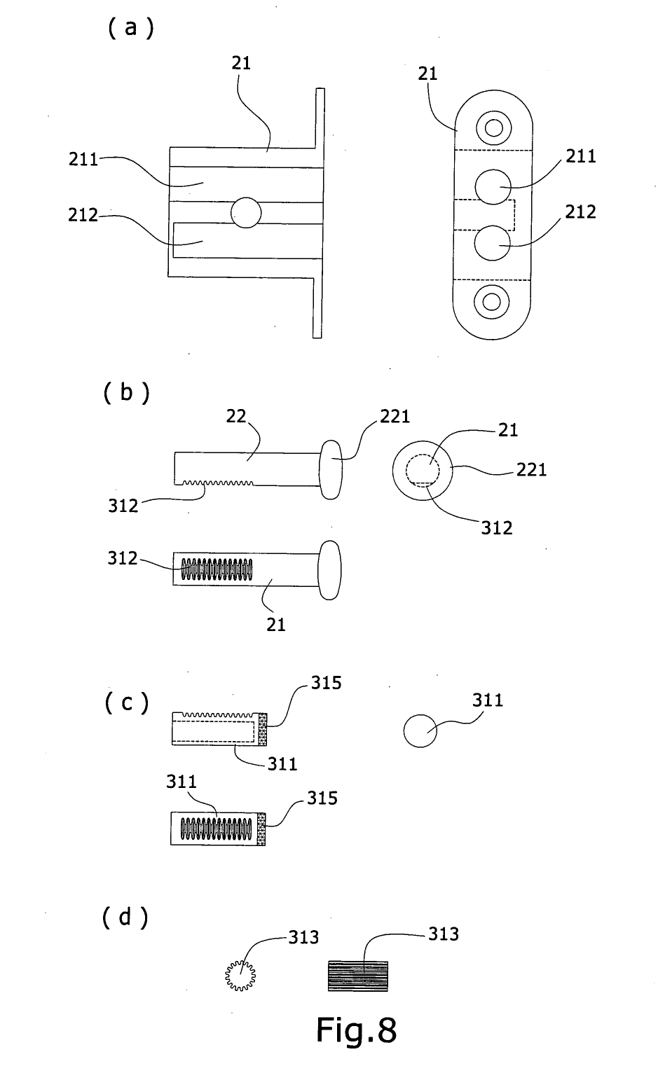

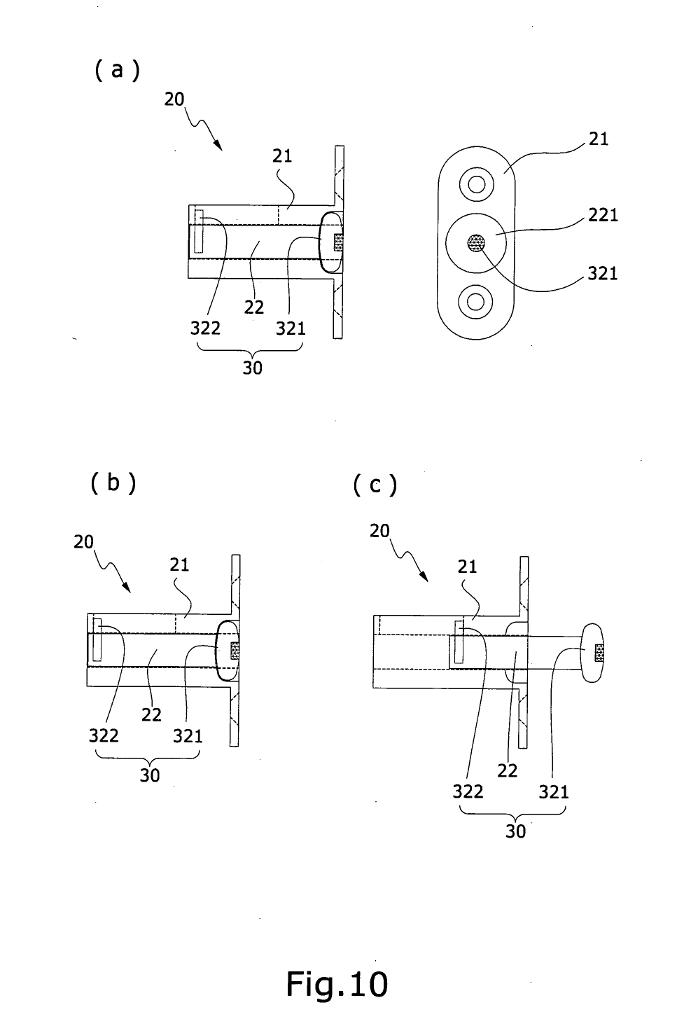

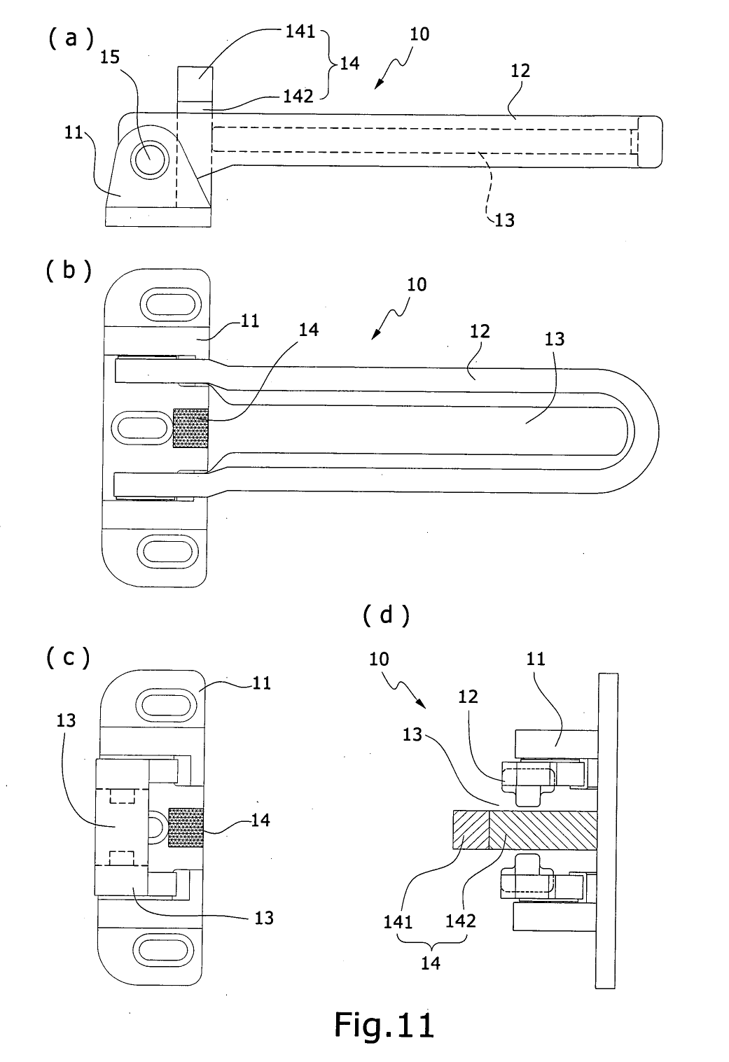

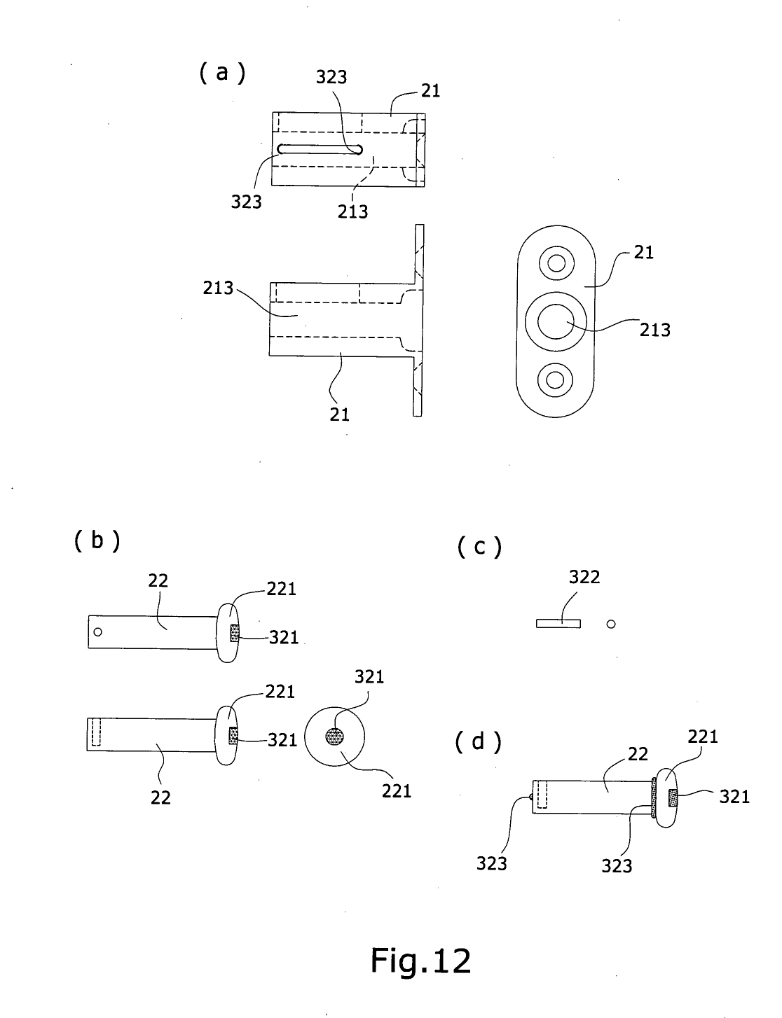

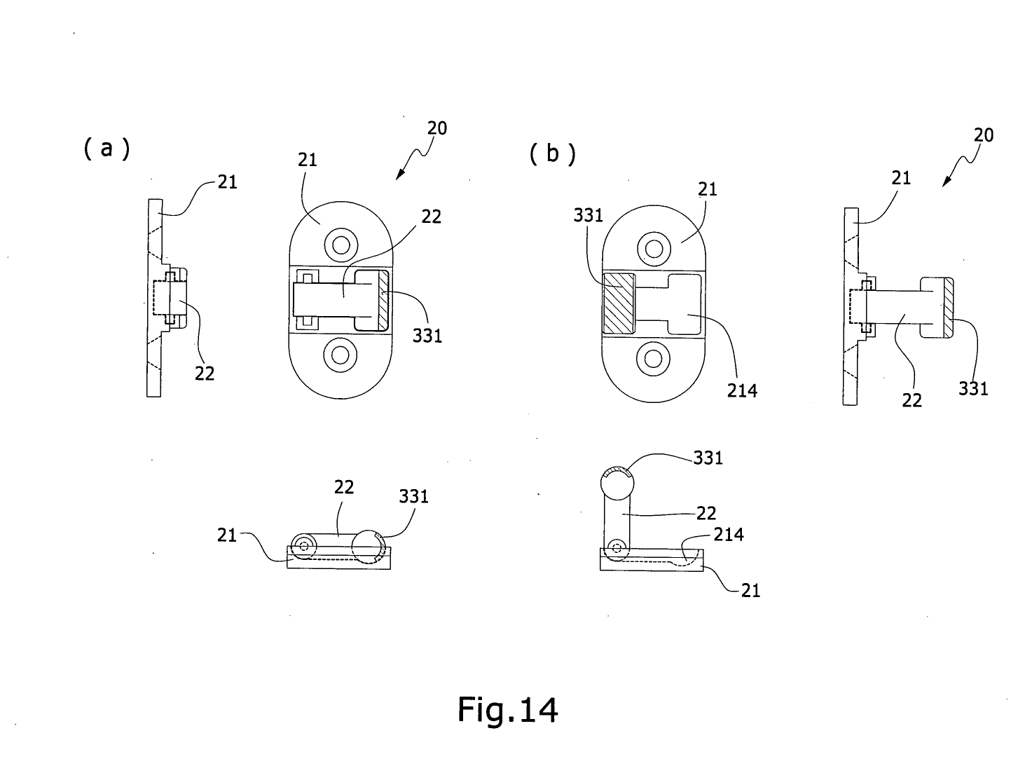

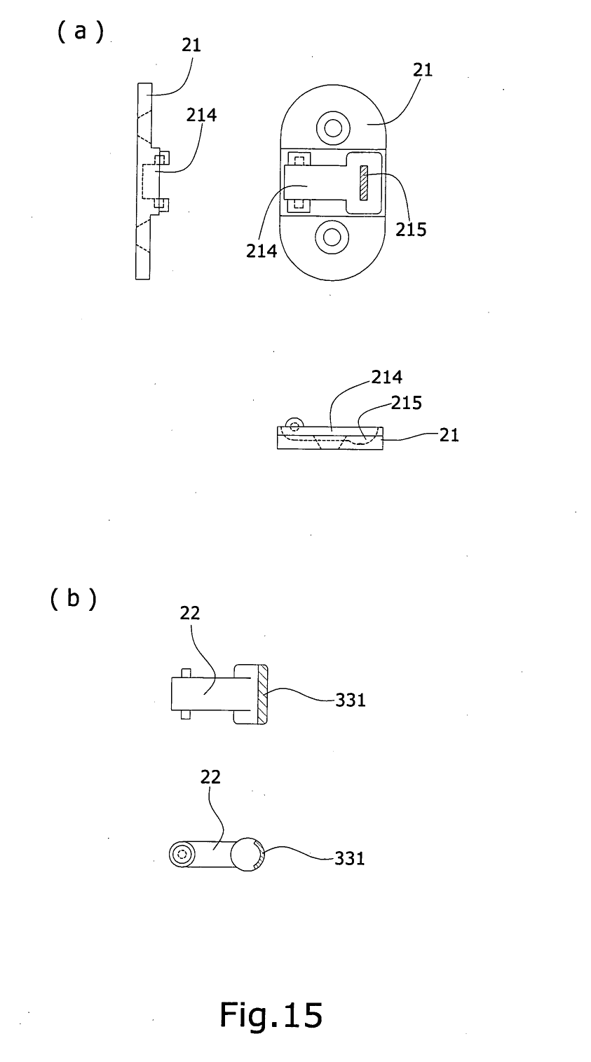

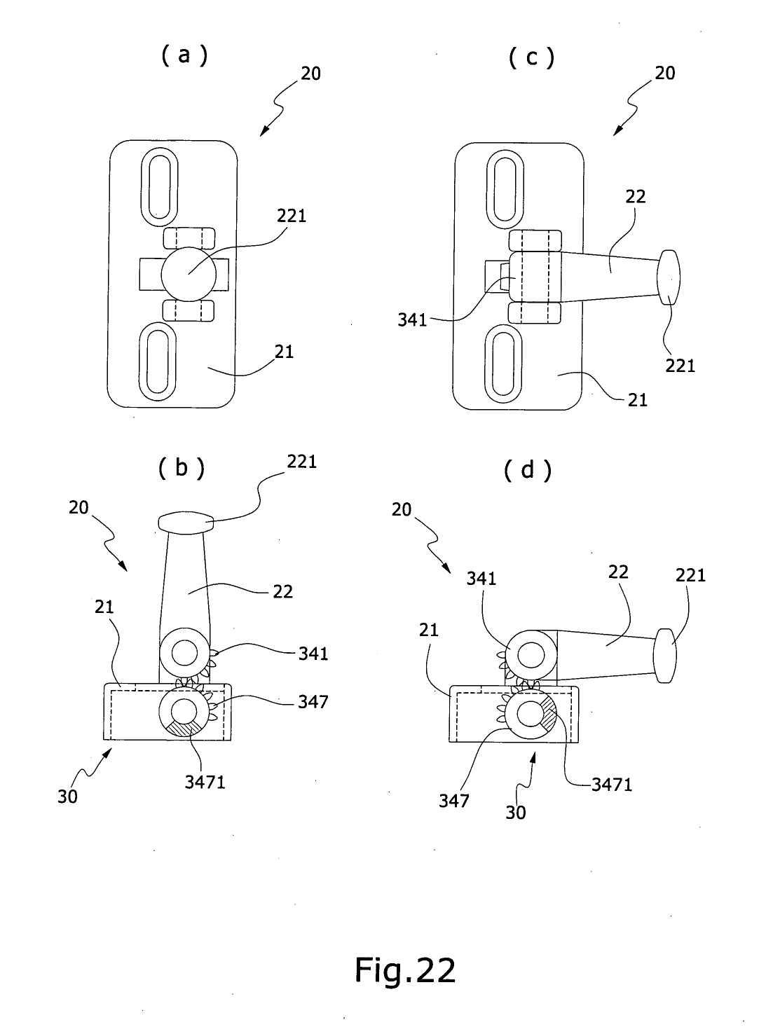

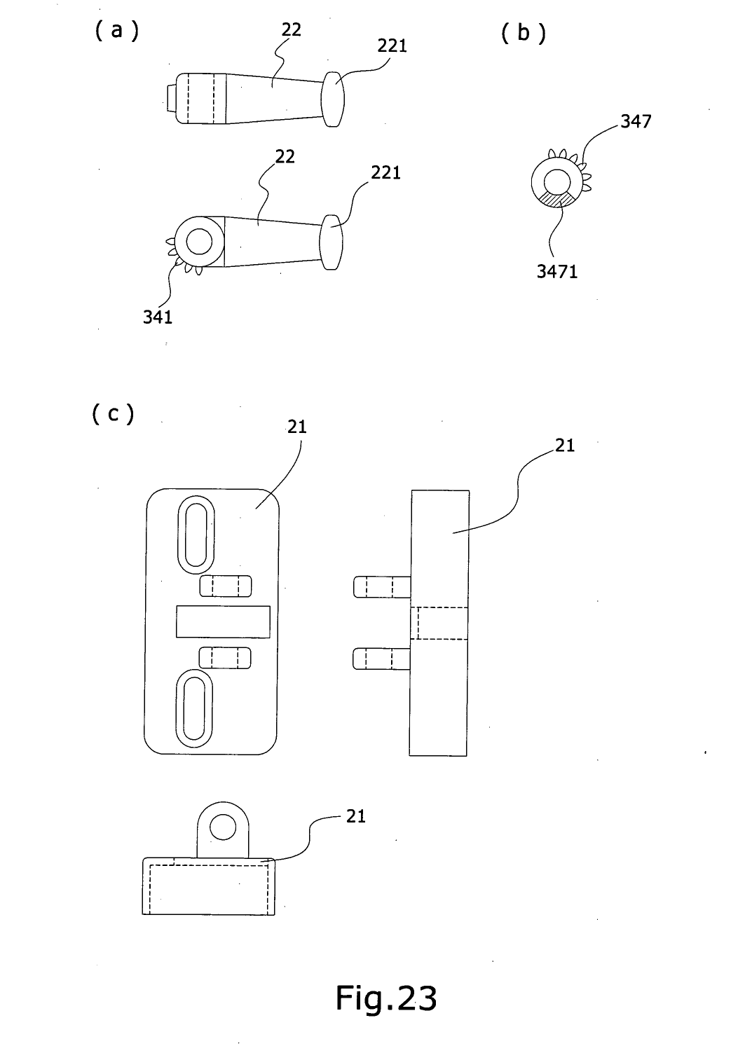

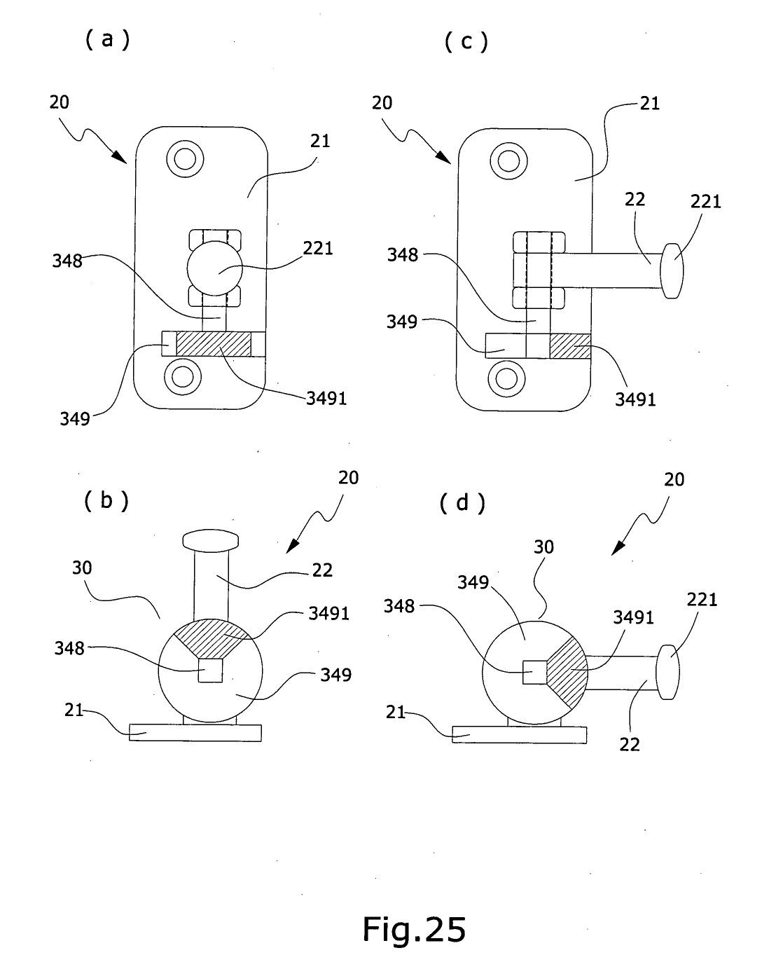

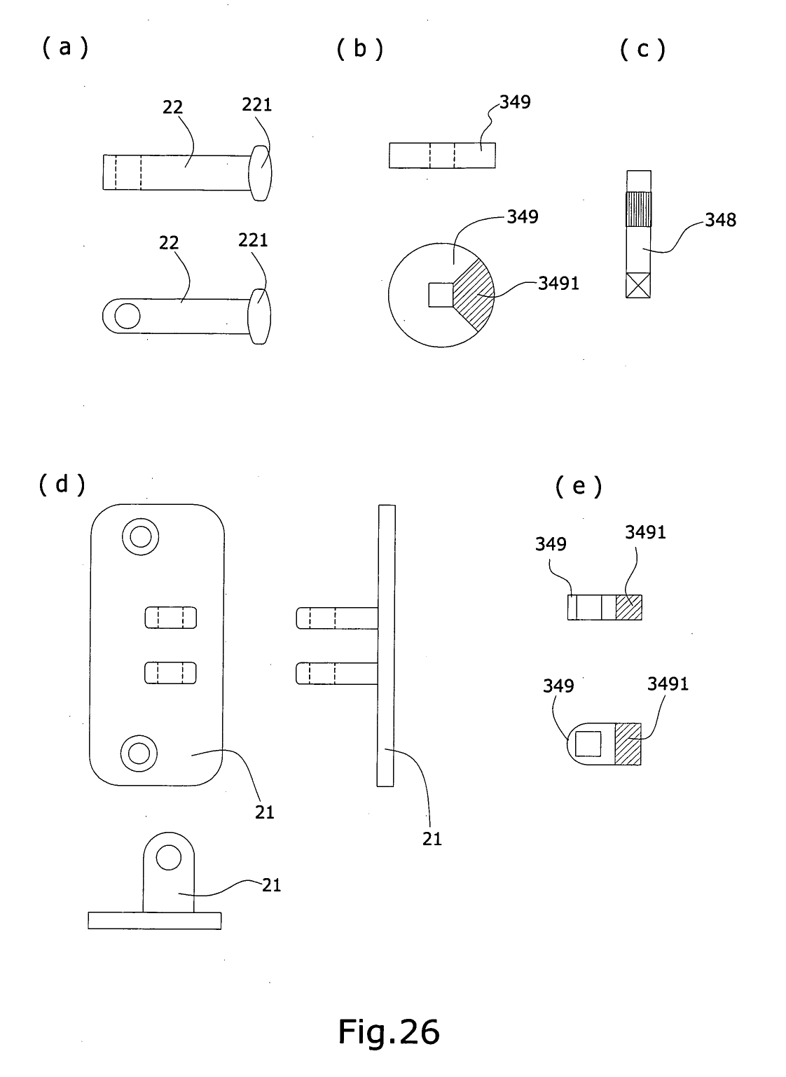

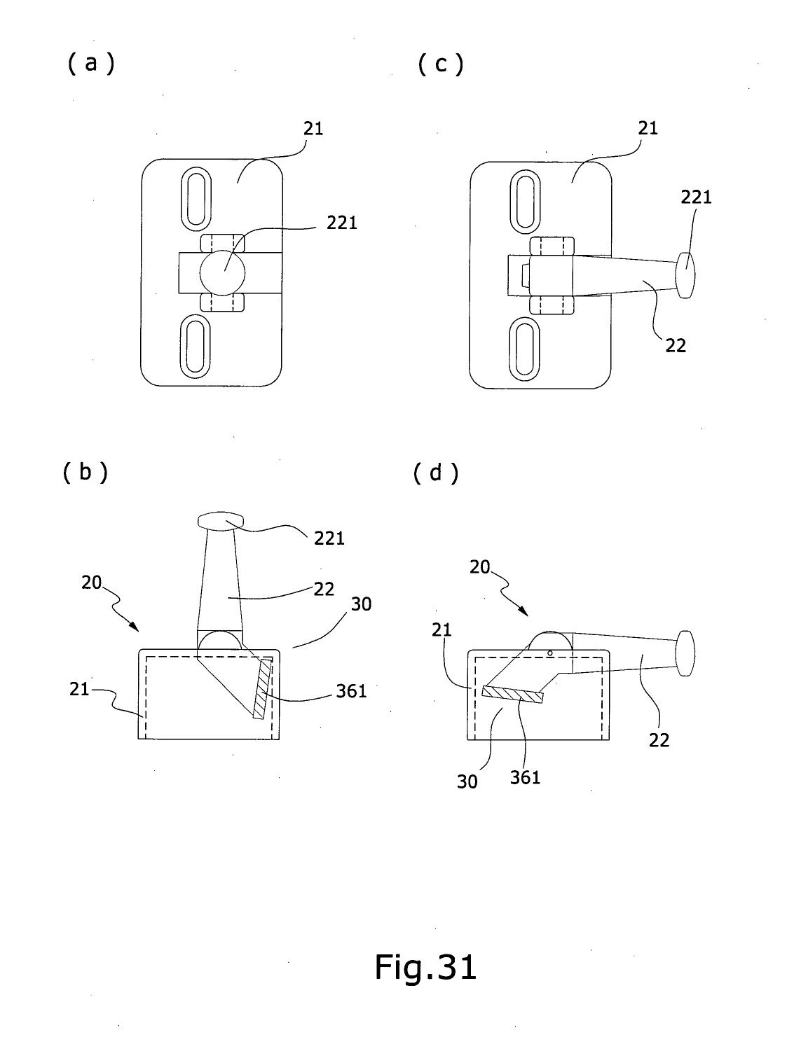

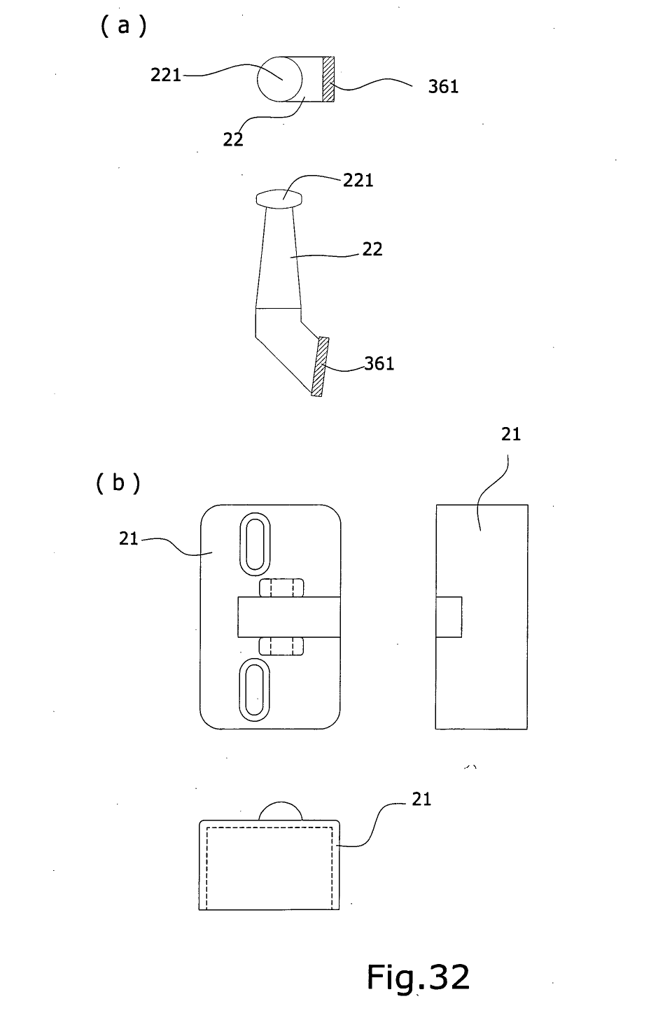

Referring first to each of the embodiments depicted in FIGS. 1 to 33 (wherein the same reference numbers indicate the same component member). A latching device as described in the present invention is structured to comprise a lock frame mechanism 10 fitted to a door 40 and a corresponding latching mechanism 20 fitted to a door frame 50. The present invention is characterized in that the lock frame mechanism 10 comprises a base 11 and a locking arm 12, wherein the base 11 is fixed to an inner side of the door 40, and the locking arm 12 is pivotal configured on the base 11 to enable horizontal (towards the direction of the latching mechanism 20) swinging of the locking arm 12. Moreover, a slide groove 13 is provided within the locking arm 12, and a drive element 14 is located on the base 11 or the locking arm 12. The latching mechanism 20 comprises a base 21 and an extension mechanism 30 provided with a latch 22. The base 21 is fixed to the door frame 50 and used to enable the extension mechanism 30 to be fitted thereto. The extension mechanism 30 is configured to correspond with the drive element 14, and thus the extension mechanism 30 is subject to the control of the drive element 14, and causes the latch 22 to extend towards the lock frame mechanism 10 and form a latched state. Similarly, control by or release from the control of the drive element 14 is used to cause the latch 22 extending towards the lock frame mechanism 10 to retract to the side of the latching mechanism 20 and form an unlatched state.

According to the aforementioned assemblage and operation of the device, when closing the door 40, the extension mechanism 30 is made to correspond with the drive element 14, whereupon then the latch 22 is subjected to the control of the drive element 14 and extends toward the direction of the lock frame mechanism 10 to form a latched state. Hence, when a user pulls open the locking arm 12 to assume a 90 degree angle with the door 40, then the latch 22 is able to insert into the slide groove 13 of the locking arm 12 to enable the door 40 to be only opened a suitable clearance, thereby achieving the effectiveness of a safety protection latching device. Moreover, when the user rotates the locking arm 12 flush with the door 40 and opens the door 40, then the latch 22, because of the drive element 14 subjecting control or releasing control of the extension mechanism 30, retracts to the side of the latching mechanism 20 to form an unlatched state, thereby achieving the effectiveness of preventing people from getting caught on an extended latch button when passing in and out, as well as further giving an integrated aesthetic appearance to the door assembly.

Referring to a first embodiment as depicted in FIGS. 1 to 4, wherein the drive element 14 of the embodiment is a press portion located at an outer side wall surface of a pivot shaft 15 of the locking arm 12, and the press portion is parallel to the locking arm 12. The extension mechanism 30 comprises the base 21 within which is defined two parallel round holes 211, 212, and the latch 22 and a toothed bar 311 are respectively located within the two round holes 211, 212. An outer end of the latch 22 is provided with a latch button 221, and an inner end is provided with a toothed portion 312 corresponding to the toothed bar 311 with an idle gear 313 located therebetween to enable reverse motion of the latch 22 relative to the toothed bar 311. In addition, a spring 314 is located on a rear end of the toothed bar 311 to enable the toothed bar 311 to maintain outward protrusion and correspond with the drive element 14 (press portion) of the locking arm 12.

Accordingly, when the door 40 is closed and the locking arm 12 rotated 90 degrees perpendicular to the door 40, then the aforementioned drive element 14 exactly presses down on the outer side end of the toothed bar 311 of the extension mechanism 30 causing the toothed bar 311 to inwardly retract, whereupon linkage of the idle gear 313 causes the latch 22 to outwardly extend and directly insert into the slide groove 13 of the locking arm 12 to form a latched state. Conversely when the locking arm 12 is rotated flush with the door, then the drive element 14 releases pressing on the outer side end of the toothed bar 311, and the elastic force of the spring 314 causes the toothed bar 311 to return to a position protruding out the base 21, and linkage of the idle gear 313 drives and causes the latch 22 to retract rearward to form an unlatched state, thereby achieving the objectives as described in the present invention.

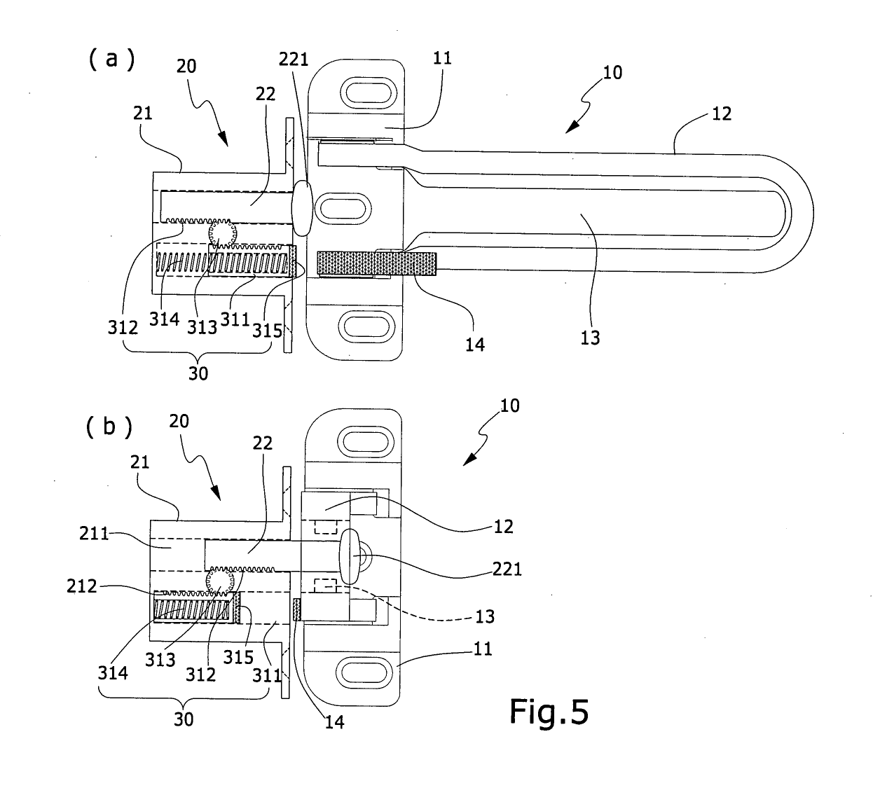

Referring to a second embodiment as depicted in FIGS. 5 to 8, wherein the drive element 14 of the embodiment is a magnet located at the outer side wall surface of the pivot shaft 15 of the locking arm 12, and the extension mechanism 30 is structured according to the first embodiment. Moreover, a homopolar magnet 315 is located on the outer side end of the toothed bar 311 corresponding to the drive element 14 (magnet).

Accordingly, when the door is closed and the locking arm 12 rotated 90 degrees perpendicular to the door, then a repelling effect is produced between the aforementioned drive element 14 (magnet) and the homopolar magnet 315 at the outer side end of the toothed bar 311, which has the ability to rearward compress the toothed bar 311. Conversely, when the locking arm 12 is flush with the door, then the drive element 14 releases the magnetic repelling pressure on the toothed bar 311, thereby achieving the same effectiveness as the first embodiment.

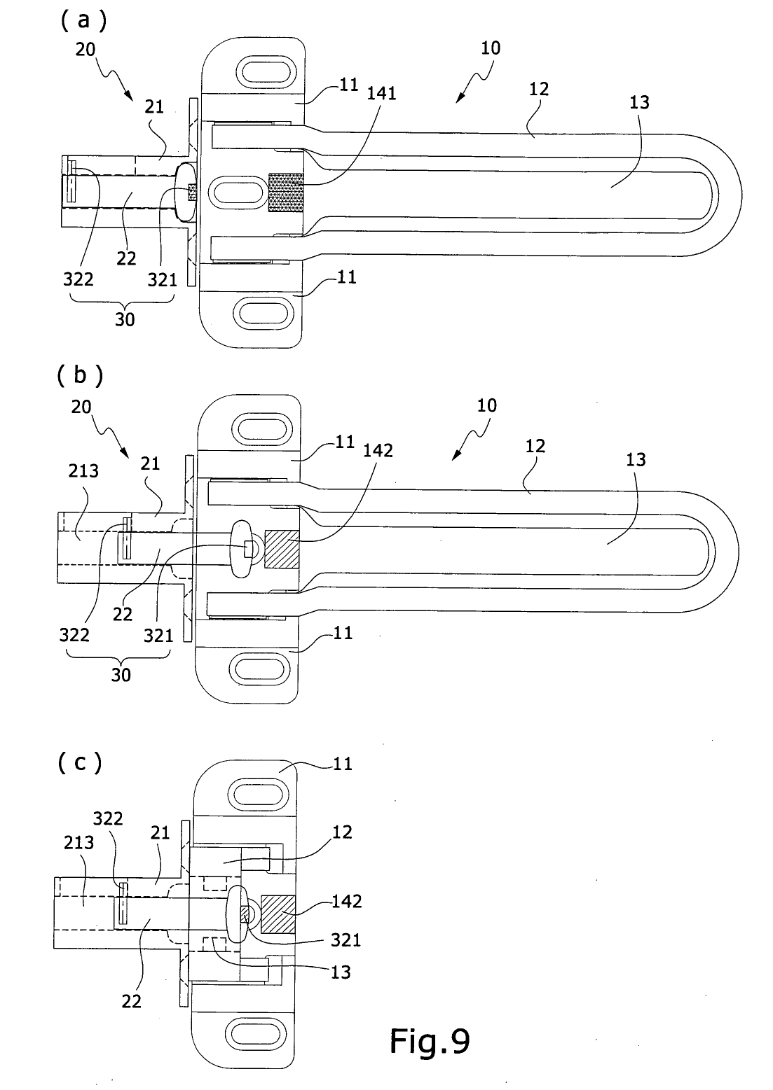

Referring to a third embodiment as depicted in FIGS. 9 to 12, wherein the drive element 14 of the embodiment is a magnetic column perpendicularly located at the center of the base 11, and the drive element 14 (magnetic column) is separated into an upper section and a lower section respectively comprising an upper magnet 141 and a lower magnet 142 having different magnetic poles. The extension mechanism 30 comprises the base 21, the round hole 213 of which has the latch 22 located therein, and the latch 22 is able to extend into and retract from the round hole 213. Furthermore, the outer end of the latch 22 is provided with the latch button 221, and a magnet 321 is located in the center of the latch button 221 corresponding to the drive element 14 (magnetic column). Moreover, the magnet 321 has the same polarity as that of the upper magnet 141 of the drive element 14. In addition, a positioning pin 322 is located on the latch 22, and the positioning pin 322 is used to limit extension and retraction distance of the latch 22 to within the round hole 213 of the base 21. Moreover, cushion material 323 can be further located at an appropriate position on the latch 22 to reduce noise and impact force during movement thereof.

Accordingly, when the door is closed, then the lower magnet 142 of the drive element 14 exactly corresponds with the magnet 321 at the outer end of the latch 22 and produces an attractive effect between the opposite poles, thereby attracting and causing the latch 22 to outwardly extend to form a latched state. Conversely when the locking arm 12 is flush with the door and the door is opened, then instantaneous production of a repelling effect between the same polarities of the magnet 321 at the outer end of the latch 22 and the upper magnet 141 on the drive element 14 pushes the latch 22 rearward into the round hole 213 of the base 21 to form an unlatched state.

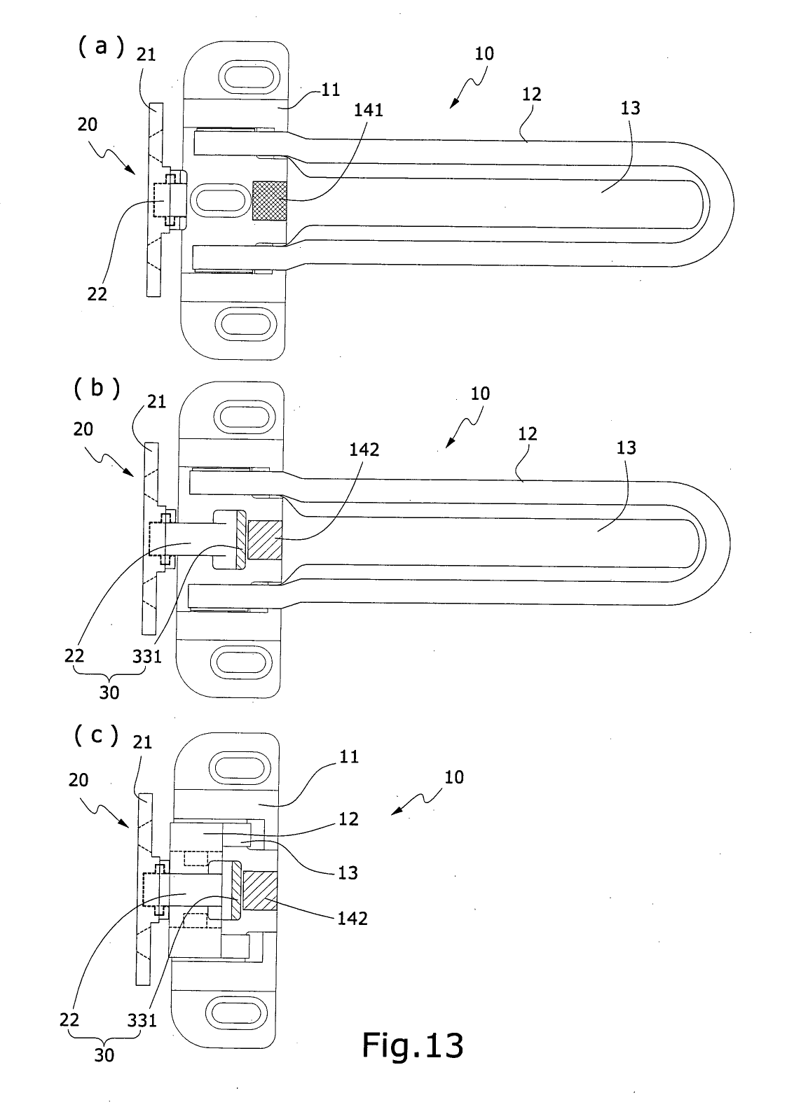

Referring to a fourth embodiment as depicted in FIGS. 13 to 15, wherein the drive element 14 of the embodiment is the same as that in the third embodiment, and the extension mechanism 30 comprises the base 21 on which is pivotal configured the latch 22 able to horizontally swing towards the direction of the lock frame mechanism 10, and a magnet 331 corresponding to the drive element 14 (magnetic column) is located on the latch button 221 of the outer end of the latch 22. Moreover, the magnet 331 has the same polarity as the upper magnet 141 of the drive element 14. In addition, a groove 214 corresponding to the shape of the latch 22 is defined in the base 21, and the groove 214 is used to hold the latch 22 when it retracts. Moreover, a ferrous metal (or magnet) 215, provided with attractive fixing effectiveness, is located within the groove 214 corresponding to the magnet 331 at the outer side end of the latch 22.

Accordingly, similar to the third embodiment, the lower magnet 142 of the drive element 14 (magnetic column) is able to attract the magnet 331 at the outer end of the latch 22, thereby causing the latch 22 to swing towards the lock frame mechanism 10 and form a latched state. Conversely, instantaneous production of a repelling effect between the magnet 331 at the outer end of the latch 22 and the upper magnet 141 of the drive element 14 causes the latch 22 to swing rearward and return to within the groove 214 of the base 21 and form an unlatched state. In addition, the magnet 331 of the outer end of the latch 22 is used to mutually attract the ferrous metal 215 within the groove 214, thereby enabling stable attractive attachment of the latch 22 within the groove 214 and providing optimum use effectiveness.

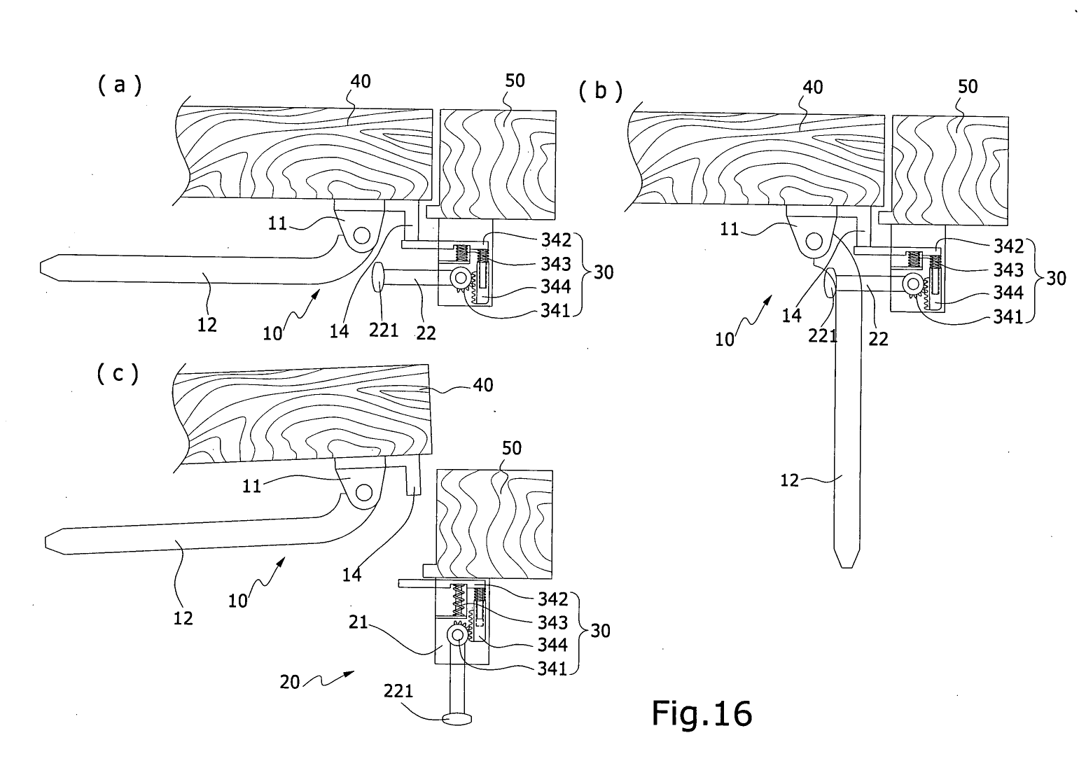

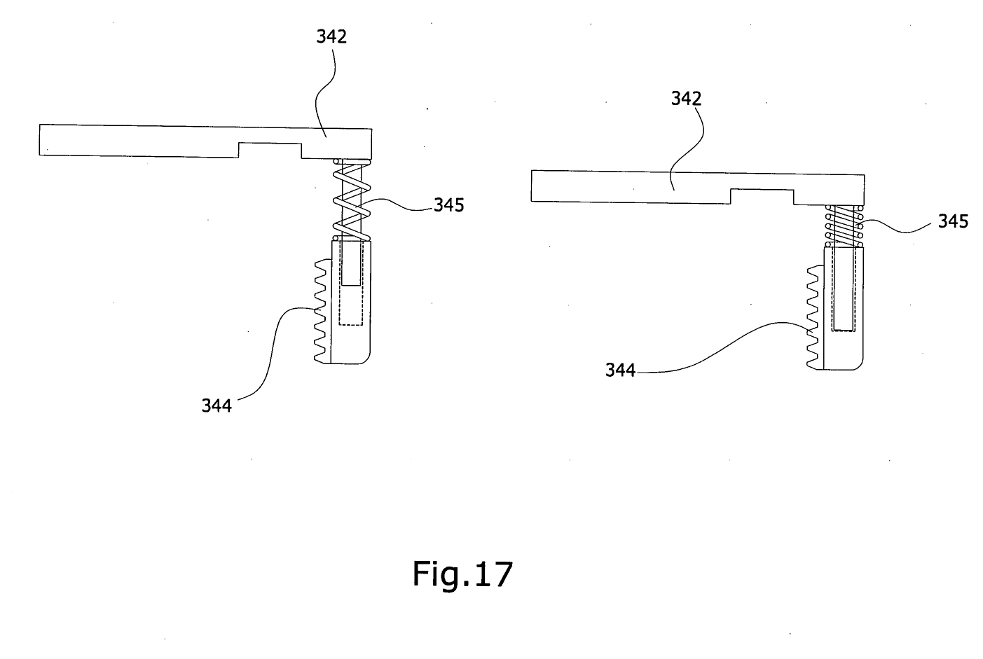

Referring to a fifth embodiment as depicted in FIGS. 16 and 17, wherein the drive element 14 of the embodiment is a top bar perpendicularly located at the center of the base 11, and the extension mechanism 30 comprises the base 21 on which is pivotal configured the latch 22 able to horizontally swing towards the direction of the lock frame mechanism 10, and the outer end of the horizontally swinging latch 22 is provided with the latch button 221. Moreover, a gear 341 is located at a pin connected end of the latch 22, and a vertically movable L arm 342 is located within the base 21 with a spring 343 being used to retain the L arm 342 in a lower fixed position. One of the bars of the L arm 342 is provided with a toothed portion 344 that mutually meshes with the gear 341, while the other bar of the L arm 342 is exposed outside the base 21 to correspond with the drive element 14 (top bar) and is upwardly displaceable. According to the aforementioned structure, the toothed portion 344 can be a movable element mounted onto the L arm 342, and a spring 345 can be located between the toothed portion 344 and the L arm 342, thereby enabling the spring 345 to be used to regulate movement range of the toothed portion 344, and providing effectiveness to cushion (delay) the unlocking movement.

Accordingly, when the door 40 is closed, then the drive element 14 (top bar) causes forward ejection of the L arm 342 of the extension mechanism 30, after which the latch 22 is caused to swing towards the lock frame mechanism 10 to form a latched state by means of the toothed portion 344 and the gear 341. Conversely, when the locking arm 12 is flush with the door 40 and the door is opened, then the drive element 14 draws back and releases the ejection effect of the L arm 342. The spring 343 then pushes back the L arm 342 to its original position while at the same time the toothed portion 344 drives and reverse rotates the gear 341, thereby causing the latch 22 to swing back to the door frame 50 and form an unlatched state.

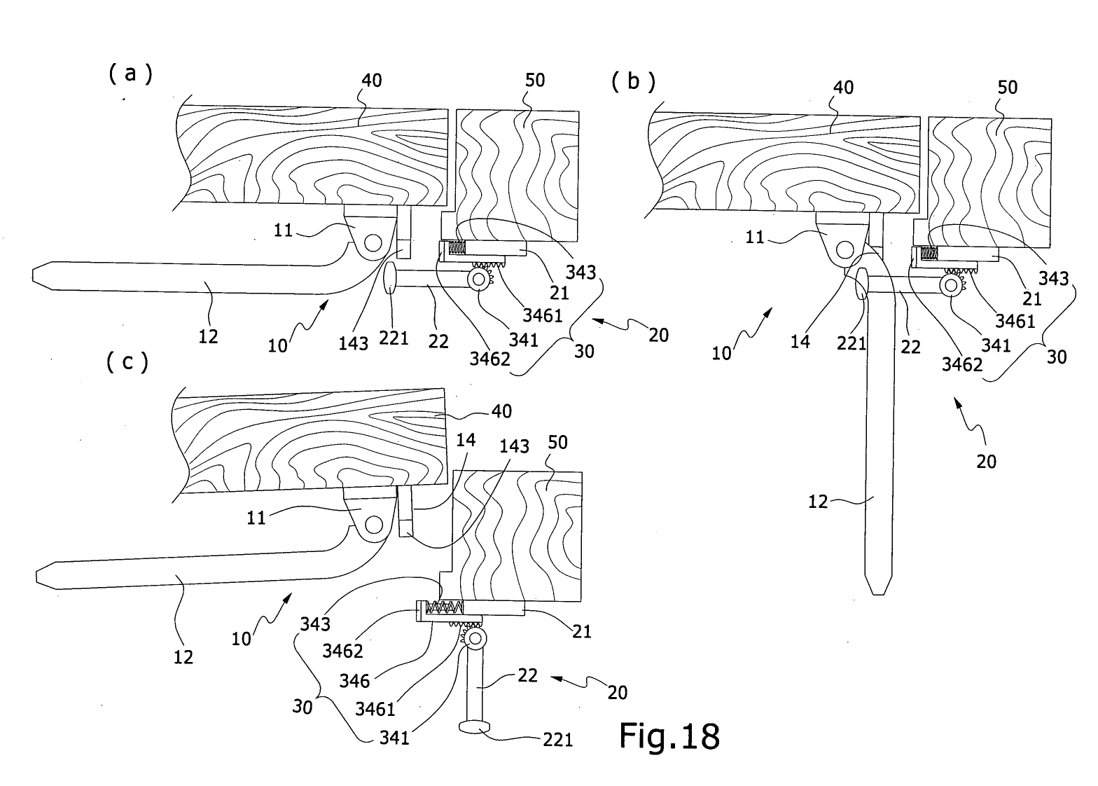

Referring to a sixth embodiment as depicted in FIG. 18, wherein the drive element 14 of the embodiment is a bar perpendicularly located at a center of the base 11, and a magnet 143 (or the drive element 14 is a magnet) is located at a top end of the drive element 14 (bar). The extension mechanism 30 comprising the base 21 on which is pivotal configured the latch 22 is the same as that of the fifth embodiment, and the base 21 is further horizontally configured with a sliding plate 346 capable of forward and rearward movement. A toothed portion 3461 that mutually meshes with the gear 341 is located on the rear end of the sliding plate 346, and a homopolar magnet 3462 is located at the front end corresponding to the magnet 143 at the top end of the drive element 14. The sliding plate 346 at the same time uses the spring 343 to maintain a forward protruding state thereof.

Accordingly, when the door 40 is closed, then a repelling effect produced between the magnet 143 at the top end of the drive element 14 (bar) and the homopolar magnet 3462 at the front end of the sliding plate 346 causes the sliding plate 346 to rearwardly retract, at which time linkage between the toothed portion 3461 and the gear 341 causes the latch 22 to swing and extend out, thereby forming a latched state. Conversely, when the locking arm is flush with the door 40 and the door is opened, then the polarity of the magnet 143 of the drive element 14 releases the magnetic repelling force on the homopolar magnet 3462 at the front end of the sliding plate 346, and the elastic force of the spring 343 is further used to restore the sliding plate 346 to its original position, which at the same time causes the latch 22 to swing back to the door frame 50 and form an unlatched state by means of the toothed portion 3461 driving and reverse rotation of the gear 341.

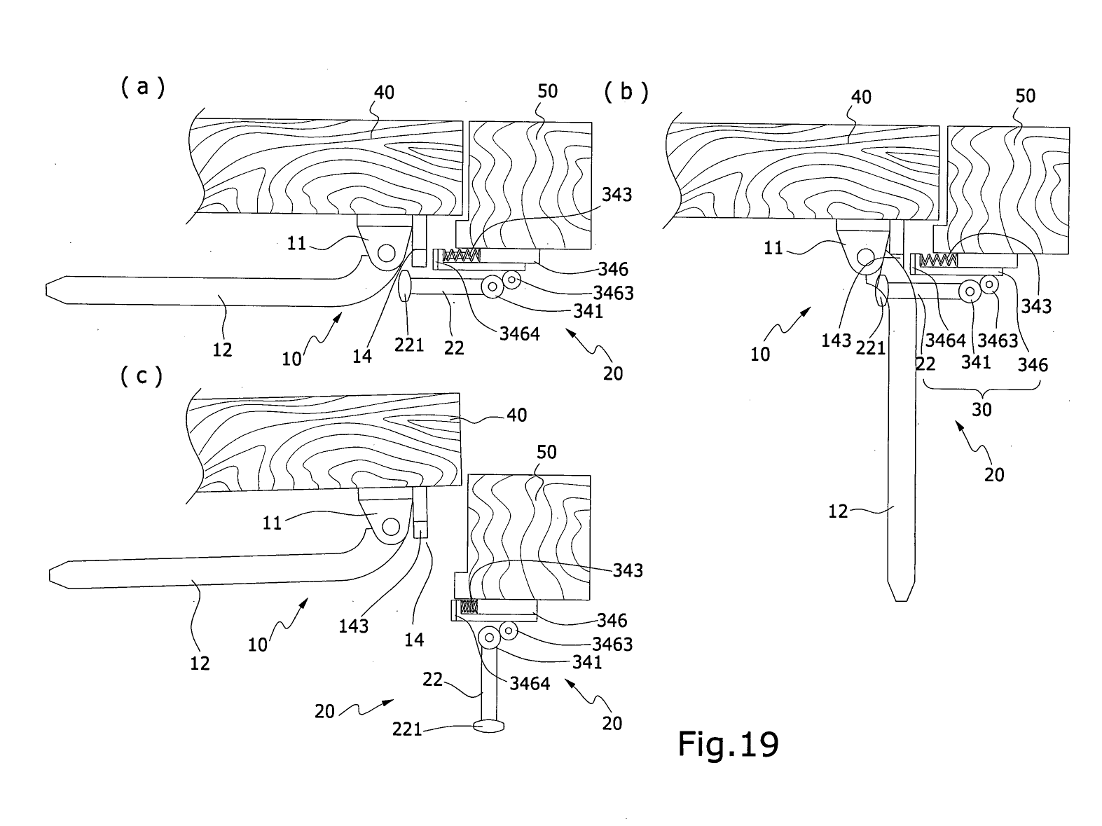

Referring to a seventh embodiment as depicted in FIG. 19, which is derived according to the structure of the sixth embodiment, wherein the toothed portion 3461 at the rear end of the sliding plate 346 uses an idle gear 3463 to mutually mesh with the gear 341 at the pin connected end of the latch 22, and a heteropolar magnet 3464 is located at the front end of the sliding plate 346.

Accordingly, when the magnet 143 at the top end of the drive element 14 produces an attractive effect towards the heteropolar magnet at the front end of the sliding plate 346 of the embodiment, then the sliding plate 346 is caused to extend forward, at which time, because of the linkage between the toothed portion 3461, the idle gear 3463 and the gear 341, the latch 22 simultaneously swings forward to form a latched state. Conversely, an unlatched state is formed when the latch 22 swings back to the door frame 50.

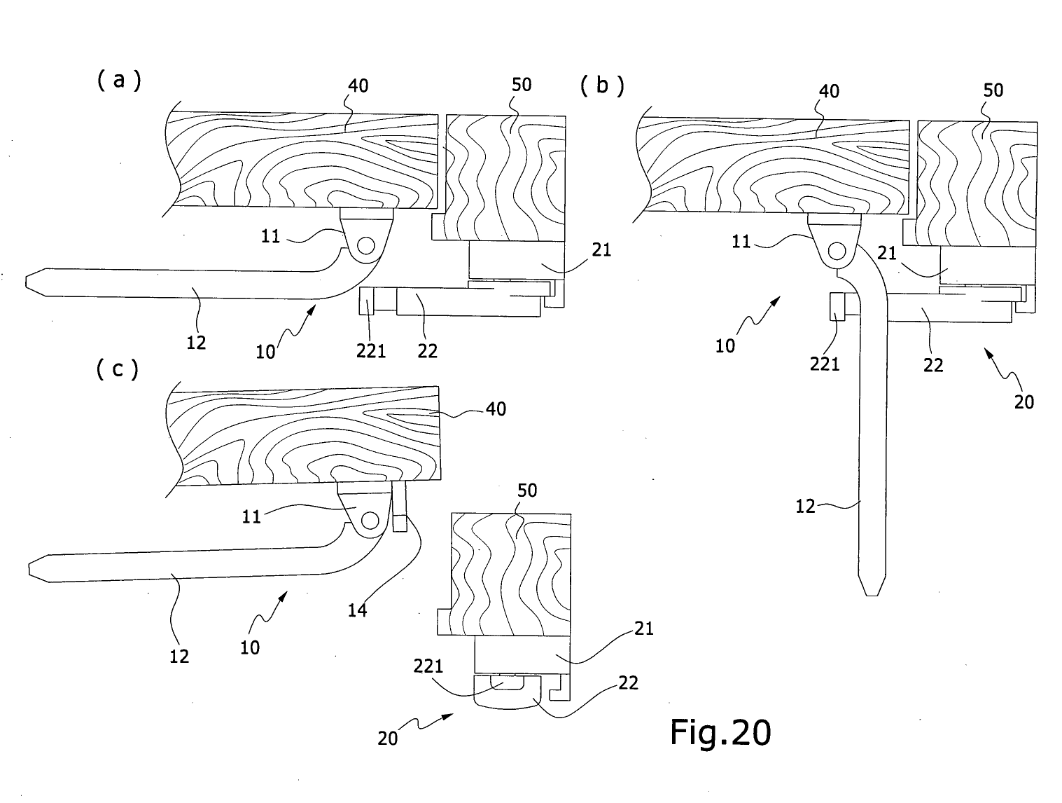

Referring to an eighth embodiment as depicted in FIG. 20, wherein the drive element 14 and the structure of the extension mechanism 30 are the same as those depicted in the sixth and seventh embodiments (and thus omitted from the drawing), and only the design of the latch 22 in the extension mechanism 30 has been changed into a configuration that perpendicularly swings towards the direction of the lock frame mechanism 10, thereby enabling the latch 22 to swing towards or retract from the direction of the lock frame mechanism 10, thereby similarly achieving the objectives of the present invention.

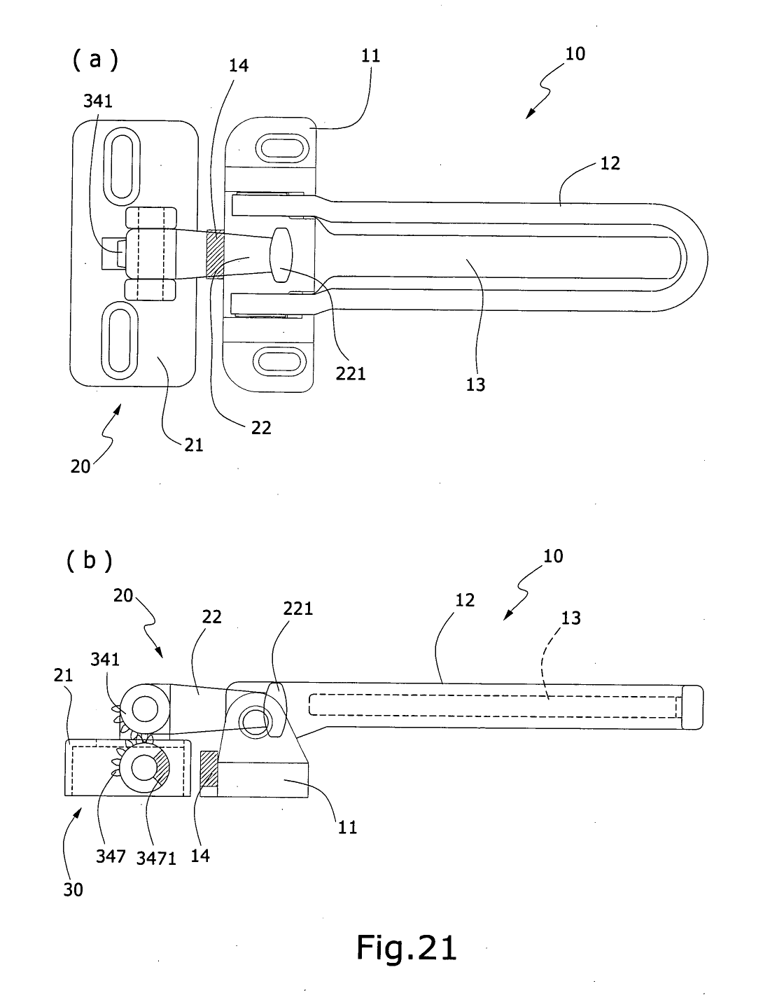

Referring to a ninth embodiment as depicted in FIGS. 21 to 23, wherein the drive element 14 of the embodiment and the latch 22 of the expansion mechanism 30 are the same as the structures disclosed in the sixth embodiment, and a drive gear 347 is located within the base 21. The drive gear 347 is used to actuate the latch 22 by meshing with the gear 341 at the pin connected end of the latch 22. Moreover, a heteropolar magnet 3471 is located at an edge of the drive gear 347 corresponding to the magnet 143 at the top end of the drive element 14, thereby enabling the drive gear 347 to rotate from the pulling force of magnetic attraction.

Accordingly, when the door 40 is closed, the magnet 143 at the top end of the drive element 14 attracts the heteropolar magnet 3471 at one side of the drive gear 347, thereby causing the heteropolar magnet 3471 to rotate to the closest position relative to the magnet 143, and linkage between the drive gear 347 and the gear 341 causes the latch 22 to form a latched state. Conversely, when the door 40 is opened, the magnet 143 at the top end of the drive element 14 attracts the heteropolar magnet 3471 to drive and reverse rotate the gear 341, thereby causing the latch 22 to swing rearward and realize the effectiveness of an unlatched state.

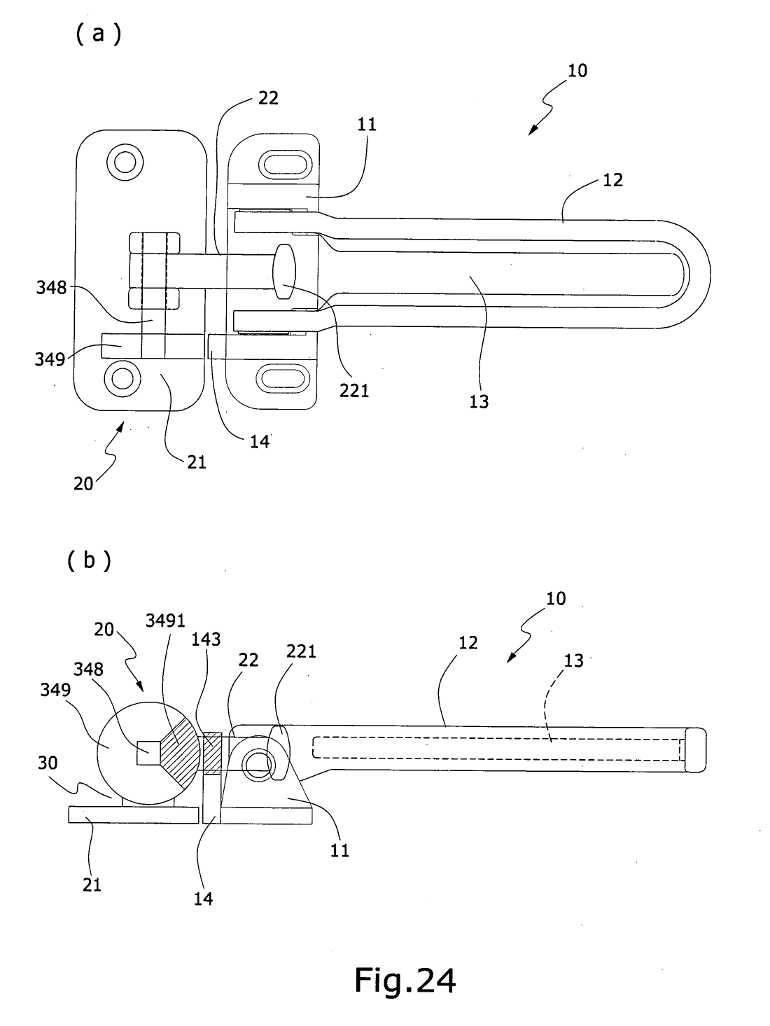

Referring to a tenth embodiment as depicted in FIGS. 24 to 26, wherein the drive element 14 of the embodiment is a bar fixed to one side of a front side surface of the base 11, and the magnet 143 is located at the top end of the drive element 14 (bar). The extension mechanism 30 comprises the base 21 on which is pivotal configured the latch 22, and a rotating wheel 349 is fixedly located to an end of a rotating shaft 348 of the latch 22. Moreover, a heteropolar magnet 3491 is located at an edge of the rotating wheel 349 corresponding to the magnet 143 at the top end of the drive element 14. Accordingly, when the door is closed, the rotating wheel 349 uses the attractive force between the magnet 143 at the top end of the drive element 14 and the heteropolar magnet 3491 to drive and rotate the latch 22.

According to the aforementioned structure, the tenth embodiment is similar to the ninth embodiment, and can similarly use the attractive force between the magnet 143 at the top end of the drive element 14 and the heteropolar magnet 3491 at one side the rotating wheel 349 during the opening and closing movement of the door, thereby achieving effectiveness to control the latch 22 to form a latched state or an unlatched state. Furthermore, the tenth embodiment can also use the restoring force of a spring (omitted in the drawing) to enable the latch 22 to even more conveniently and substantially achieve the efficacy of rearward retraction.

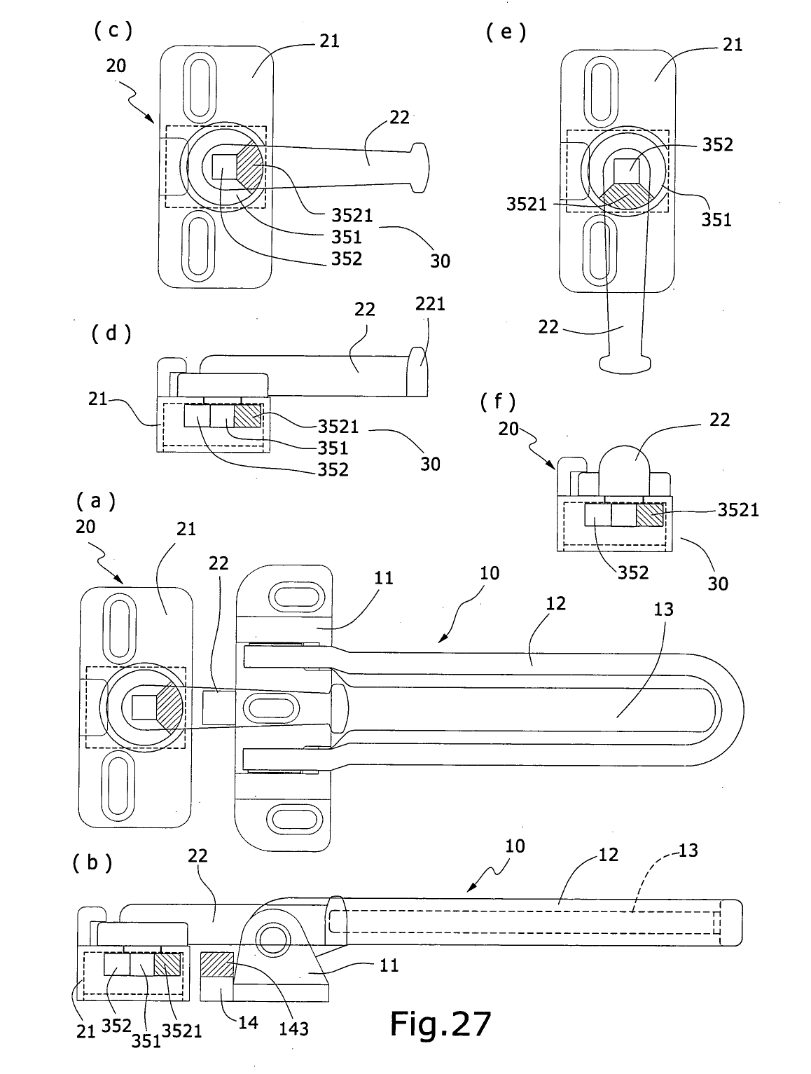

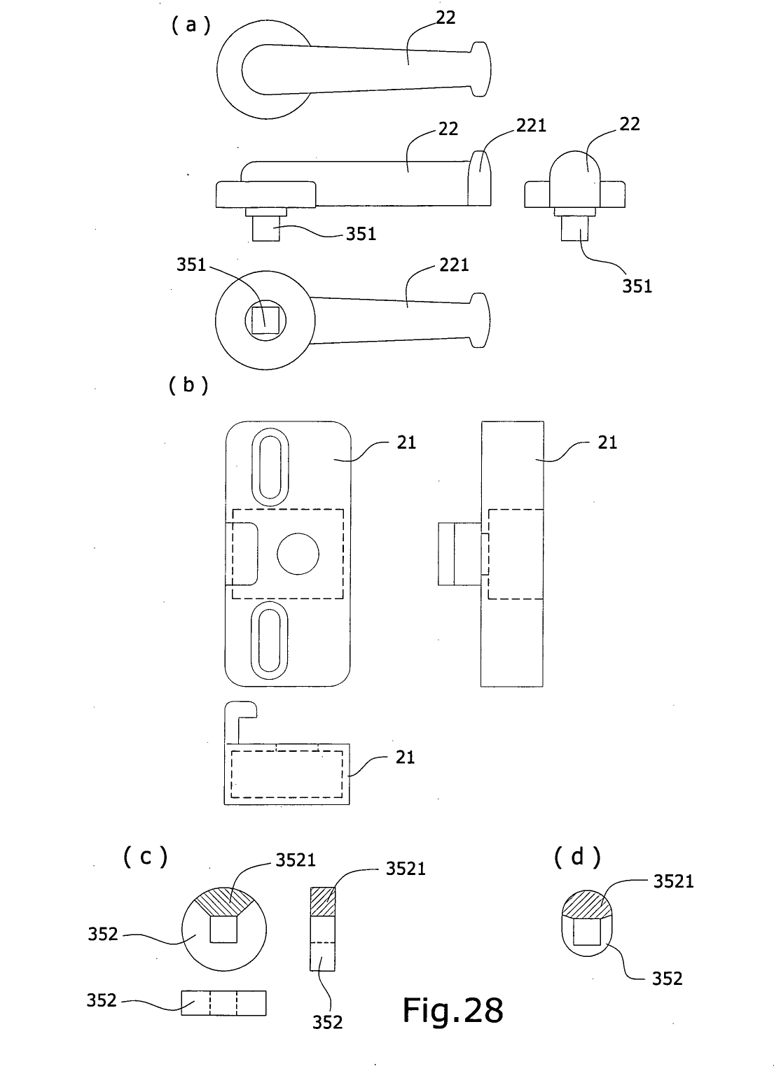

Referring to an eleventh embodiment as depicted in FIGS. 27 to 28, which is a configuration derived from the ninth and tenth embodiments, in which the latch 22 of the extension mechanism 30 has been changed into a structure (identical to the eighth embodiment) able to perpendicularly swing towards the direction of the lock frame mechanism 10, and a rotating wheel 352 is similarly fixedly located to a rotating shaft 351 of the latch 22. Moreover, a heteropolar magnet 3521 is located at an edge of the rotating wheel 352 corresponding to the magnet 143 of the top end of the drive element 14.

Accordingly, when the door is closed, the magnet 143 at the end of the drive element 14 attracts the heteropolar magnet 3521 at one side of the rotating wheel 352, thereby causing the heteropolar magnet 3521 to rotate to the closest position relative to the magnet 143, and causing the latch 22 to swing towards the lock frame mechanism 10 to form a latched state. Conversely, when the locking arm 12 is flush with the door and the door is opened, because the magnet 143 at the top end of the drive element 14 separates from the heteropolar magnet 3521 on the rotating wheel 352, thus, the controlling force of magnetic attraction is lost, at which time gravitational force of the latch 22 itself causes it to automatically drop down (that is, swing back to the side of the latching mechanism 20) and form an unlatched state.

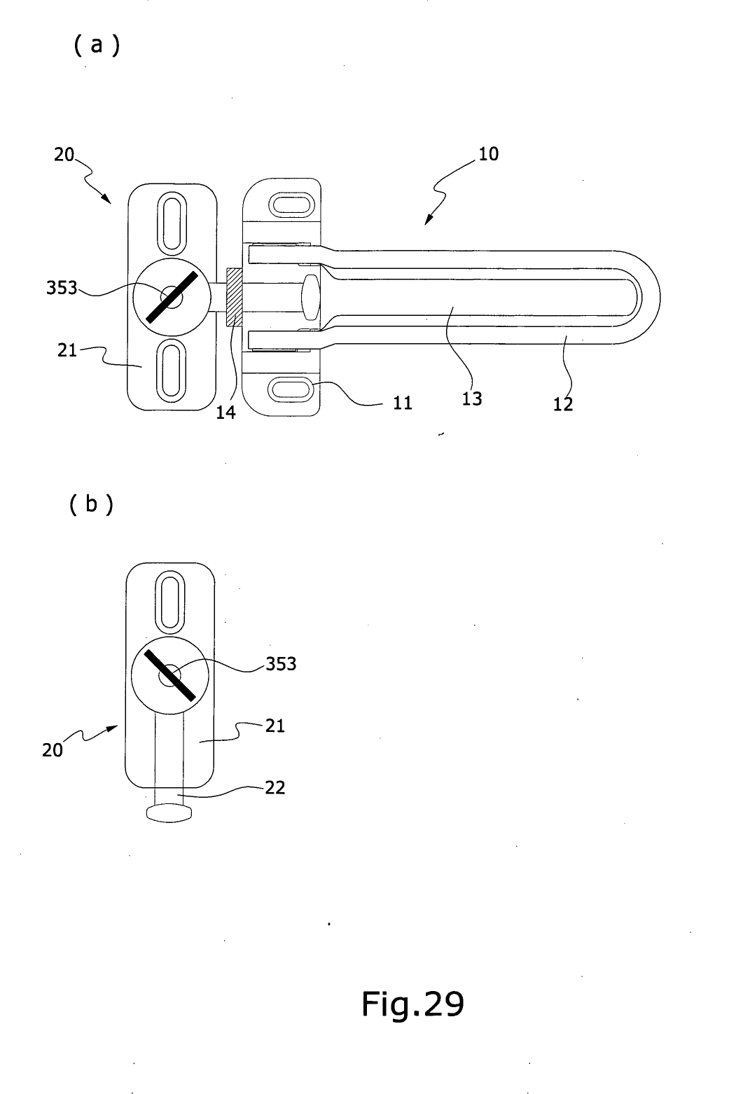

Referring to a twelfth embodiment as depicted in FIG. 29, wherein the principle and mechanism of the embodiment is the same as that of the eleventh embodiment, and only the interior of the latch 22 has been changed to have a magnetic rod 353 located therein, and two ends of the magnetic rod 353 are respectively configured as a N (north) pole and a S (south) pole. When the door is closed, an attracting and pushing effect produced between the magnet 143 at the top end of the drive element 14 and the two ends of the magnetic rod 353 causes the latch 22 to swing and form a latched state, Conversely, when the magnetic force between the drive element 14 and the magnetic rod 353 is lost, then the latch 22 is able to retract to form an unlatched state.

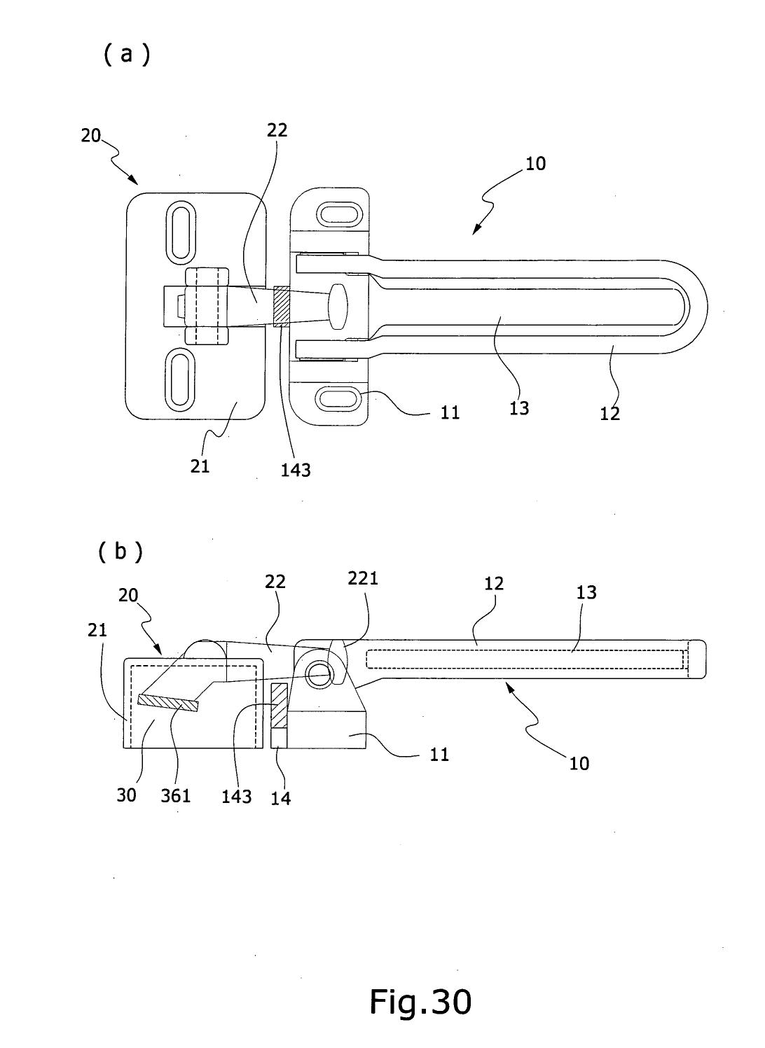

Referring to a thirteenth embodiment as depicted in FIGS. 30 to 32, wherein the drive element 14 of the embodiment has the same structure as that described in the sixth embodiment, and the extension mechanism 30 comprises the base 21 on which is pivotal configured the horizontally swinging latch 22. Center of the latch 22 serves as a pivot shaft, and the front end of the latch 22 is provided with the latch button 221, while a homopolar magnet 361 is located at the rear end to correspond with the magnet 143 at the top end of the drive element 14.

Accordingly, when the door is closed, a mutual repelling force is produced between the magnet 143 at the top end of the drive element 14 and the homopolar magnet 361 at the rear end of the latch 22, thereby causing the latch button 221 at the front end of the latch 22 to swing towards the lock frame mechanism 10 and form a latched state. Conversely, when opening the door, because the magnetic repelling force between the magnet 143 at the top end of the drive element 14 and the homopolar magnet 361 at the rear end of the latch 22 is lost, thus, the latch 22 automatically retracts or the restoring force of a spring is used to cause the latch 22 to retract and form an unlatched state.

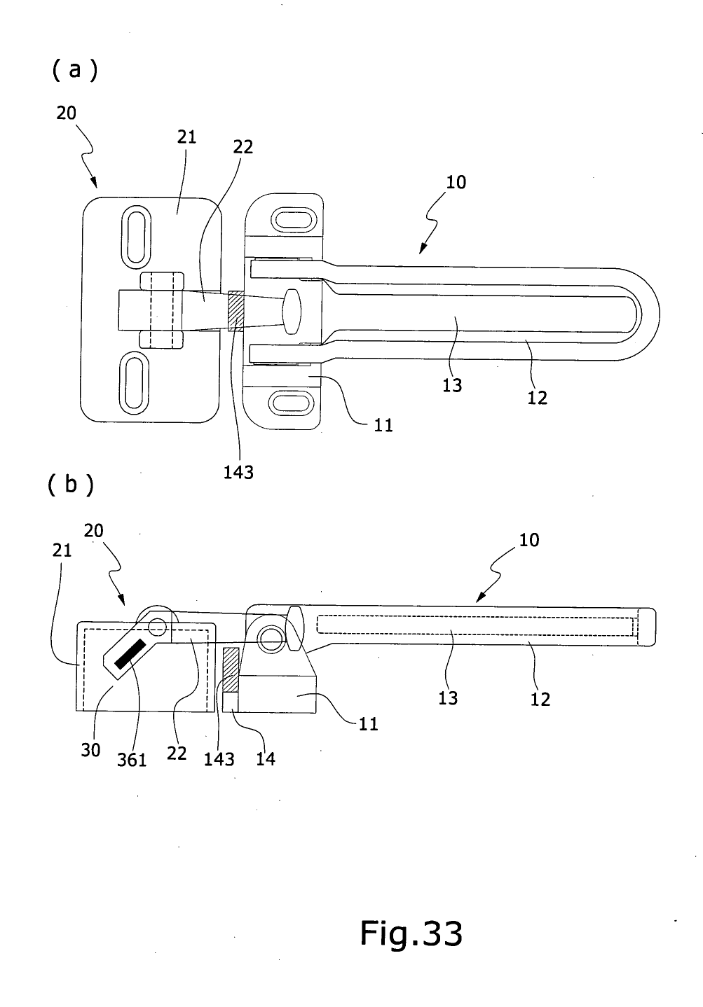

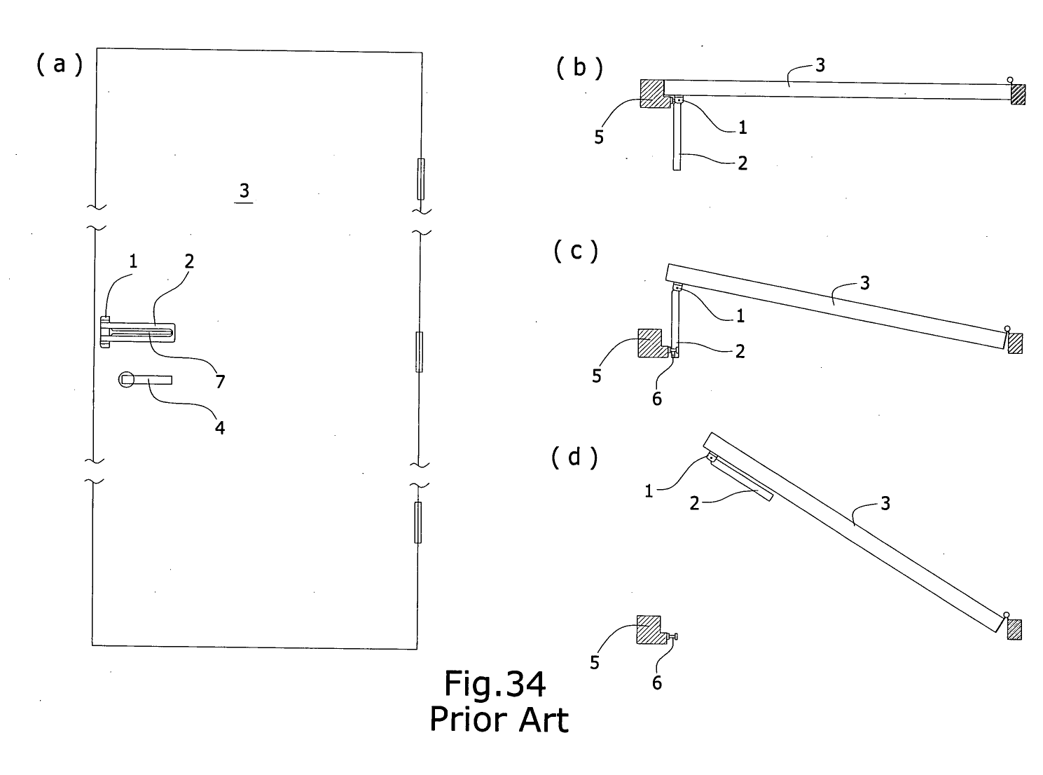

Referring to a fourteenth embodiment as depicted in FIG. 33, wherein the embodiment is identical to the thirteenth embodiment, the only difference being that the homopolar magnet 361 is installed within the rear end body of the latch 22, and functions in coordination with the magnet 143 at the top end of the drive element 14, thereby achieving identical effectiveness to that of the thirteenth embodiment.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A latching device, comprising a lock frame mechanism fitted to a door and a corresponding latching mechanism fitted to a door frame, wherein:
the lock frame mechanism comprises a base and a locking arm, the base is fixed to the inner side of the door, and the locking arm is pivotal configured on the base and able to horizontally swing, moreover, a slide groove is defined within the locking arm, and a drive element is located on the base or close to a pin connected position of the locking arm;
the latching mechanism comprises a base and an extension mechanism provided with a latch, the base is fixed to the door frame and is used to enable the extension mechanism to be fitted thereto, the extension mechanism functions in correspondence with the drive element;
whereby the drive element at the side of the lock frame mechanism controls movement of the extension mechanism at the side of the latching mechanism, thereby enabling the latch to extend towards the lock frame mechanism and form a latched state, and control by or release from the control of the drive element is used to cause the latch on the extension mechanism to retract and form an unlatched state.

2. The latching device according to claim 1, wherein the drive element is a press portion located at an outer side wall surface of a pivot shaft of the locking arm; the extension mechanism comprises the latch, a toothed bar, an idle gear and a spring fitted to the base; the toothed bar corresponds with the drive element of the locking arm, and when the toothed bar is pressed into the base, then the latch extends outward to form a latched state; and when pressure on the toothed bar is released, then the latch automatically retracts to form an unlatched state.

3. The latching device according to claim 1, wherein the drive element is a magnet located at the outer side wall surface of the pivot shaft of the locking arm; the extension mechanism comprises the latch, the toothed bar, the idle gear and the spring fitted to the base, and a homopolar magnet is located at the front end of the toothed bar; when the drive element (magnet) corresponds to the homopolar magnet, then a repelling force is produced therebetween causing the latch to outwardly extend and form a latched state, and when pressure on the toothed bar is released, then the latch automatically retracts to form an unlatched state.

4. The latching device according to claim 1, wherein the drive element is a magnetic column perpendicularly located at the center of the base, and the drive element is separated into an upper section and a lower section respectively comprising an upper magnet and a lower magnet having different magnetic poles; the latch is located within the extension mechanism, the outer end of the latch is provided with a latch button, and a magnet is located in the center of the latch button corresponding to the drive element, moreover, the magnet has the same polarity as that of the upper magnet of the drive element; when the lower magnet of the drive element is in correspondence with the magnet at the front end of the latch, thereby producing a magnetic attraction therebetween, then the latch is caused to outwardly extend to form a latched state; conversely, when the upper magnet of the drive element is in correspondence with the magnet at the front end of the latch, thereby producing a repelling force therebetween, then the latch-automatically retracts to form an unlatched state.

5. The latching device according to claim 2, wherein the latch is designed to have a configuration which is pivotal configured on the base, and is able to horizontally swing towards the direction of the lock frame mechanism.

6. The latching device according to claim 3, wherein the latch is designed to have a configuration which is pivotal configured on the base, and is able to horizontally swing towards the direction of the lock frame mechanism.

7. The latching device according to claim 4, wherein the latch is designed to have a configuration which is pivotal configured on the base, and is able to horizontally swing towards the direction of the lock frame mechanism.

8. The latching device according to claim 1, wherein the drive element is a top bar perpendicularly located at the center of the base; the extension mechanism comprises the base on which is pivotal configured the latch able to horizontally swing towards the direction of the lock frame mechanism, and a gear is located on the horizontally swinging latch, a vertically movable L arm is further located within the base, and a spring is used to retain the L arm in a lower fixed state; one of the bars of the L arm is provided with a toothed portion that mutually meshes with the gear of the latch, while the other bar of the L arm is exposed outside the base to correspond with the drive element and is upwardly displaceable.

9. The latching device according to claim 8, wherein the toothed portion located on the L arm is mounted on the L arm and is a movable element, moreover, a spring is located between the toothed portion and the L arm, and the spring is used to regulate movement range of the toothed portion.

10. The latching device according to claim 1, wherein the drive element is a magnet perpendicularly located at the center of the base; the extension mechanism comprises the base on which is pivotal configured the horizontally swinging latch, and a gear is located at a pin connected end of the latch, and the base is horizontally configured with a sliding plate capable of forward and rearward movement, a toothed portion that mutually meshes with the gear is located on the rear end of the sliding plate, and a homopolar magnet is located at the front end corresponding to the magnet of the drive element; the sliding plate further uses a spring to maintain a forward protruding state.

11. The latching device according to claim 1, wherein the drive element is a magnet perpendicularly located at the center of the base; the extension mechanism comprises the base on which is pivotal configured the horizontally swinging latch, and a gear is located at a pin connected end of the latch, and the base is horizontally configured with the sliding plate capable of forward and rearward movement, the toothed portion located at the rear end of the sliding plate uses an idle gear to mutually mesh with the gear of the latch, and a heteropolar magnet is located at the front end of the sliding plate corresponding to the magnet of the drive element; the sliding plate further uses a spring to maintain a forward protruding state.

12. The latching device according to claim 1, wherein the drive element is a magnet fixed to one side of a front side surface of the base; the extension mechanism comprises the base on which is pivotal configured the latch able to horizontally swing towards the direction of the lock frame mechanism, a rotating wheel is fixedly located to an end of a rotating shaft of the latch, and a heteropolar magnet is located at an edge of the rotating wheel to correspond with the magnet of the drive element, the attractive force of the drive element towards the rotating wheel is used to cause the rotating wheel to rotate.

13. The latching device according to claim 8, wherein the latch is designed to have a configuration which is pivotal configured on the base, and is able to vertically swing towards the direction of the lock frame mechanism.

14. The latching device according to claim 10, wherein the latch is designed to have a configuration which is pivotal configured on the base, and is able to vertically swing towards the direction of the lock frame mechanism.

15. The latching device according to claim 11, wherein the latch is designed to have a configuration which is pivotal configured on the base, and is able to vertically swing towards the direction of the lock frame mechanism.

16. The latching device according to claim 12, wherein the latch is designed to have a configuration which is pivotal configured on the base, and is able to vertically swing towards the direction of the lock frame mechanism.
